(19) United States
(12) Patent Application Publication
(10) Pub. No.: US 2003/0186144 A1
(43) Pub. Date: Oct. 2, 2003

(54) ELECTROPHOTOGRAPHIC PHOTOSENSITIVE MEMBER, PROCESS CARTRIDGE AND ELECTROPHOTOGRAPHIC APPARATUS

(76) Inventors: MITSUHIRO KUNIEDA, SHIZUOKA-KEN (JP); TOSHIHIRO KIKUCHI, YOKOHAMA-SHI (JP); TETSURO KANEMARU, TOKYO (JP); YUKA KAISHA, SHIZUOKA-KEN (JP)

Correspondence Address: FITZPATRICK CELLA HARPER & SCINTO, 30 ROCKEFELLER PLAZA, NEW YORK, NY, 10112, US

(21) Appl. No.: 09/361,803

(22) Filed: Jul. 27, 1999

(30) Foreign Application Priority Data
Jul. 31, 1998 (JP) 217770/1998
Jul. 31, 1998 (JP) 217779/1998
Jul. 31, 1998 (JP) 217780/1998

(51) Int. Cl. G03G 5/047

(52) U.S. Cl. 430/58.8; 430/58.05; 430/58.65; 430/58.75; 347/225

(57) ABSTRACT

An electrophotographic photosensitive member, irradiated with semiconductor laser light having a wavelength of 380 to 500 nm, includes a conductive substrate, a charge-generating layer formed thereon; and a charge transport layer formed thereon, the charge transport layer having a transmittance of at least 30% for the semiconductor laser light. A process cartridge mountable to and detachable from an electrophotographic apparatus includes the electrophotographic photosensitive member. An electrophotographic apparatus also includes the electrophotographic photosensitive member.

### BACKGROUND OF THE INVENTION

1. Field of the Invention

The present invention relates to electrophotographic photosensitive members, process cartridges and electrophotographic apparatuses. In particular, the present invention relates to an electrophotographic photosensitive member and to a process cartridge which are suitable for short-wave semiconductor lasers capable of forming high-resolution images, and relates to an electrophotographic apparatus having a short-wavelength semiconductor laser as an exposure light source.

Description of the Related Art Semiconductor lasers having oscillation wavelengths near 800 nm or 680 nm have been primarily used as laser light sources in electrophotographic apparatuses, such as laser printers. A variety of approaches for increasing resolution have been attempted to satisfy the requirements for high-quality output images. As disclosed in Japanese Patent Application Laid-Open No. 9-240051, the shorter the oscillation wavelength of the laser, the smaller the spot diameter of the laser. The smaller spot diameter enables formation of high-resolution latent images.

There are several methods for achieving short-wavelength laser oscillation. One method is a combination of the use of a nonlinear optical material and second harmonic generation (SHG) to reduce the wavelength of the laser light to one-half, as disclosed in Japanese Patent Application Laid-Open Nos. 9-275242, 9-189930, and 5-313033. The technology in this system as a primary light source has been established. This method generally uses GaAs semiconductor lasers and YAG lasers having high output which can prolong the service life of the apparatus.

Another method is the use of a wide-gap semiconductor which facilitates miniaturization of an apparatus compared to a SHG device. Many wide-gap semiconductors have been researched in view of high luminous efficiency and include, for example, ZnSe semiconductor lasers disclosed in Japanese Patent Application Laid-Open Nos. 7-32409 and 6-334272 and GaN semiconductor lasers disclosed in Japanese Patent Application Laid-Open Nos. 8-88441 and 7-335975.

In these semiconductor lasers, however, it is difficult to optimize the device configuration, the conditions for crystal growth, and the electrode. For example, defects in the crystal complicates oscillation over long periods at room temperature, which is essential for practical use. The most usable semiconductor laser is a GaN semiconductor laser which sustains 1,150 hours of continuous oscillation at 50° C. (disclosed in October 1997), as a result of technical innovation.

Conventional laser electrophotographic photosensitive members used in electrophotographic apparatuses are designed so as to have practical levels of sensitivity to a long-wavelength region of approximately 700 to 800 nm. These electrophotographic photosensitive members use charge generation materials, such as nonmetal phthalocyanines and metal phthalocyanines, e.g., copper phthalocyanine and oxytitanium phthalocyanine, which do not have absorption bands at 400 to 500 nm. Thus, these electrophotographic photosensitive members do not have practical levels of sensitivity to a wavelength region of 400 to 500 nm due to insufficient generation of carriers.

The use of a charge-generating material having a sufficient absorption band at 400 to 500 nm does not always achieve sufficiently high sensitivity. In main electrophotographic photosensitive members, generation of charged carriers and transfer of the charged carriers are performed by different layers in order to achieve high sensitivity. In a photosensitive member having a charge-generating layer and a charge transport layer deposited on a conductive substrate in that order, exposure is performed when laser light passes through the charge transport layer and reaches the charge-generating layer. When the charge transport layer is composed of a charge transfer material having a large absorption coefficient at a short wavelength of 400 to 500 nm, the light does not sufficiently reach the charge-generating layer. Accordingly, the use of the charge-generating material having high absorption at 400 to 400 nm does not show high sensitivity.

Furthermore, short wavelength light may cause degradation or isomerization of the charge transfer material and thus cause deterioration of the charge transfer material during repeated use, even if the charge transport layer passes through the short-wavelength light of 400 to 500 nm.

### SUMMARY OF THE INVENTION

It is an object of the present invention to provide an electrophotographic photosensitive member having high sensitivity to a wavelength region of 380 to 500 nm and having a reduced change in potential during repeated use.

It is another object of the present invention to provide an electrophotographic apparatus using the electrophotographic photosensitive member and a short-wavelength laser and capable of continuously outputting high-quality images.

It is a still another object of the present invention to provide a process cartridge which is mountable to and detachable from the electrophotographic apparatus.

A first aspect of the present invention is an electrophotographic photosensitive member, irradiated with semiconductor laser light having a wavelength of 380 to 500 nm, including a conductive substrate, a charge-generating layer formed thereon, and a charge transport layer formed thereon, the charge transport layer having a transmittance of at least 30% for the semiconductor laser light.

A second aspect of the present invention is a process cartridge mountable to and detachable from an electrophotographic apparatus including an electrophotographic photosensitive member, and at least one means selected from a charging means, a developing means and a cleaning means, the electrophotographic photosensitive member being integratedly supported by the means, wherein the electrophotographic photosensitive member includes a conductive substrate, a charge-generating layer formed thereon, and a charge transport layer formed thereon, the charge transport layer having a transmittance of at least 30% for the semiconductor laser light.

A third aspect of the present invention is an electrophotographic apparatus including an electrophotographic photosensitive member, a charging means, an exposure means, a developing means, and a transfer means, wherein the exposure means includes a semiconductor laser having an oscillation wavelength of 380 to 500 nm as an exposure light source, and the electrophotographic photosensitive member comprises a conductive substrate, a charge-generating layer formed thereon, and a charge transport layer formed thereon, the charge transport layer having a transmittance of at least 30% for the semiconductor laser light.

Further objects, features and advantages of the present invention will become apparent from the following description of the preferred embodiments with reference to the attached drawings.

### BRIEF DESCRIPTION OF THE DRAWINGS

FIG. 1 is a cross-sectional view of a layer configuration of an electrophotographic photosensitive member of the present invention;

FIG. 2 is a cross-sectional view of a layer configuration of an electrophotographic photosensitive member of the present invention;

FIG. 3 is a cross-sectional view of a layer configuration of an electrophotographic photosensitive member of the present invention;

FIG. 4 is a cross-sectional view of a layer configuration of an electrophotographic photosensitive member of the present invention;

FIG. 5 is a schematic cross-sectional view of an electrophotographic apparatus having a process cartridge of the present invention; and

FIG. 6 shows transmission spectra of charge transport layers at an exposure wavelength region.

### DESCRIPTION OF THE PREFERRED EMBODIMENTS

The electrophotographic photosensitive member in accordance with the present invention is irradiated with semiconductor laser light having a wavelength in a range of 380 to 500 nm, and has a charge transport layer which has a transmittance of 30% for the semiconductor laser light.

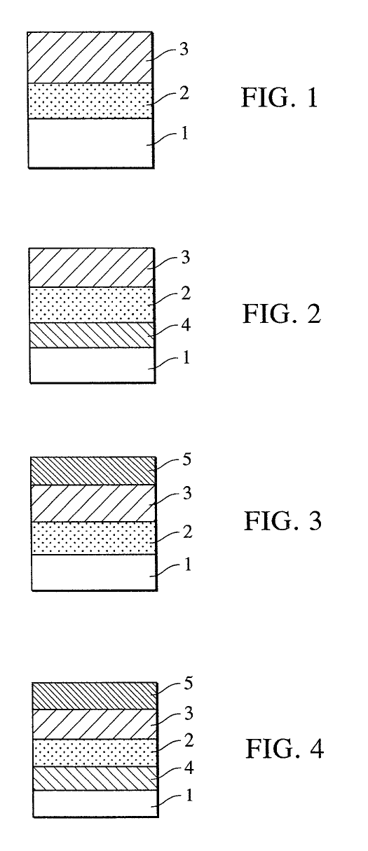

FIGS. 1 to 4 are cross-sectional views of exemplary layer configurations in a layered electrophotographic photosensitive member having a conductive substrate, a charge-generating layer formed thereon and a charge transport layer formed thereon. In FIG. 1, the electrophotographic photosensitive member includes a conductive substrate 1, a charge-generating layer 2 formed thereon, and a charge transport layer formed thereon. In FIG. 2, the electrophotographic photosensitive member further includes an underlying layer 4 formed on the conductive substrate, in addition to the layers shown in FIG. 1. In FIG. 3, the electrophotographic photosensitive member further includes a protective layer 5 formed on the charge transport layer 3, in addition to the layers shown in FIG. 1. In FIG. 4, the electrophotographic photosensitive member further includes the underlying layer 2 and the protective layer 5. Any other configuration may be employed in the present invention.

The following are preferable conductive substrates used in the present invention.

(1) A plate or a cylinder composed of a metal or an alloy, e.g., aluminum, an aluminum alloy, stainless steel or copper.

(2) A nonconductive substrate, such as glass, resin or paper, or a conductive substrate composed of the above-mentioned metal or alloy, in which a metal such as aluminum, palladium, rhodium, gold or platinum is deposited or laminated on the substrate.

(3) The above nonconductive or conductive substrate, in which a conductive layer composed of a conductive polymer, tin oxide or indium oxide is formed on the substrate by a deposition or coating process.

The following are charge-generating materials preferably used in the present invention. These charge-generating materials may be used alone or in combination.

(1) Azo pigments, such as monoazo pigments, bisazo pigments, and trisazo pigments.

(2) Indigo pigments and thioindigo pigments.

(3) Phthalocyanine pigments, such as metal phthalocyanine pigments and nonmetal phthalocyanine pigments.

(4) Perylene pigments, such as perylenic anhydride and perylenic imides.

(5) Polycyclic quinone pigments, e.g., anthraquinones and pyrene quinones.

(6) Squarylium pigments

(7) Pyrylium salts and thiopyrylium salts.

(8) Triphenylmethane pigments

(9) Inorganic substances, e.g., selenium and amorphous silicon.

The charge-generating layer containing a charge-generating material is preferably formed by dispersing the charge-generating material into a proper binder and coating the dispersion onto a conductive substrate. Alternatively, it may be formed on a conductive substrate by a dry process such as a deposition, sputtering or CVD process.

The binder can be selected from a variety of binding resins. Nonlimiting examples of binding resins include polycarbonate resins, polyester resins, polyarylate resins, butyral resins, polystyrene resins, polyvinylacetal resins, diallyl phthalate resins, acrylic resins, methacrylic resins, vinyl acetate resins, phenol resins, silicone resins, polysulfone resins, styrene-butadiene copolymeric resins, alkyd resins, epoxy resins, urea resins, and vinyl chloride-vinyl acetate copolymeric resins. These resins may be used alone or in combination.

The charge-generating layer preferably contains the binding resin in an amount of 80 percent by weight or less and more preferably 40 percent by weight or less. The thickness of the charge-generating layer is preferably 5 μm or less and more preferably in a range of 0.01 μm to 2 μm. The charge-generating layer may contain a variety of sensitizers.

The charge transport layer containing a charge transfer material has a transmittance of at least 30% and preferably at least 90% for radiated laser light. It is not necessary to satisfy the transmittance for the entire wavelength range of 380 nm to 500 nm. The charge transport layer is formed of a combination of a charge transfer material and one of the above-mentioned binding resins. Further binding resins suitable for the charge transport layer are conductive polymers, such as polyvinylcarbazole and polyvinylanthracene.

The charge transfer materials are classified into electron transport materials and hole transport materials. Examples of electron transport materials include electrophilic materials, such as 2,4,7-trinitrofluorenone, 2,4,5,7-tetranitrofluorenone, chloranil and tetracyanoquinodimethane, and polymers of the electrophilic materials. Examples of hole transport materials include polycyclic aromatic compounds, such as pyrene and anthracene; heterocyclic compounds, such as carbazoles, indoles, oxazoles, thiazoles, oxadiazoles, pyrazoles, pyrazolines, thiadiazoles, and triazoles; miscellaneous compounds, such as hydrazones, styryls, benzidines, triarylmethanes, and triarylamines; and polymers having groups derived from these compounds in main or side chains, such as poly-N-vinylcarbazole and polyvinylanthracene. These charge transfer materials may be used alone or in combination.

According to the experimental results by the present inventors, a large variation in potential on the photosensitive member after repeated use and image defects, including ghosting, are noticeable in a combination of a photosensitive member using a charge-generating material having a sufficient absorption band at approximately 400 nm to 500 nm and a light source emitting light having a wavelength of approximately 400 nm, rather than a combination of a conventional photosensitive member for a longer wavelength and a light source for a longer wavelength. One factor causing such phenomena is partial accumulation of excitons and charged carriers, which are generated by irradiation of short-wavelength light having high energy and are not consumed during the electrophotographic process. Such accumulation will change charging characteristics and sensitivity of the photosensitive member. The present inventors have discovered that accumulation of the excitons and carriers can be suppressed by electron transfer reaction with a charge transfer material which can suppress a change in potential and a memory phenomenon during repeated use and can form stable high-quality images.

Since printers provided with electrophotographic photosensitive members are used in various fields, the electrophotographic photosensitive members are designed so as to provide stable images in various environments.

Thus, the charge transfer materials used in the present invention are preferably represented by the following formulae (1) to (7):

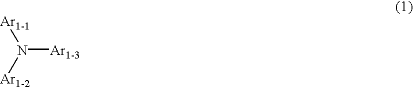

wherein Ar₁₋₁, Ar₁₋₂ and Ar₁₋₃ each is a substituted or unsubstituted aromatic group. Examples of unsubstituted aromatic groups include aryl groups, e.g., phenyl, naphthyl, anthracenyl and pyrenyl; aromatic heterocyclic groups, e.g., pyridyl, quinolyl, thienyl, furyl, benzimidazolyl and benzothiazolyl. Examples of substituent groups in the substituted aromatic groups include alkyl groups, e.g., methyl, ethyl, propyl, butyl and hexyl; alkoxy groups, e.g., methoxy, ethoxy and butoxy; halogen atoms, e.g., fluorine, chorine and bromine; aralkyl groups, e.g., benzyl, phenethyl, naphthylmethyl, and furfuryl; acyl groups, e.g., acetyl and benzyl; haloalkyl groups, e.g., trifluoromethyl; cyano groups; nitro groups; phenylcarbamoyl groups; carboxy groups; and hydroxy groups.

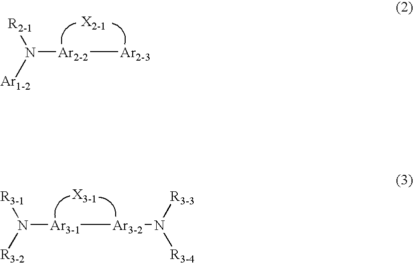

wherein Ar₂₋₁ is a substituted or unsubstituted aromatic groups, and Ar₂₋₂, Ar₂₋₃, Ar₃₋₁ and Ar₃₋₂ each is a substituted or unsubstituted aromatic group. R₂₋₁ to R₃₋₄ each is a substituted or unsubstituted alkyl group, a substituted or unsubstituted aralkyl group, a substituted or unsubstituted vinyl group, or a substituted or unsubstituted aromatic group, wherein at least two of R₃₋₁ to R₃₋₄ are the substituted or unsubstituted aromatic groups. X₂₋₁ and X₃₋₁ each is a divalent organic group, and preferably —O—, —S—, —S0₂—, —NR₁—, —CR₂═CR₃— or —CR₄R₅—, wherein R₁ to R₅ each is a substituted or unsubstituted aralkyl group. R₂₋₁ and Ar₂₋₁, R₃₋₁ and R₃₋₂, or R₃₋₃ and R₃₋₄ may form a ring directly or together with an organic group, such as —CH₂—, —CH₂CH₂—, —CH═CH—, —O—, or —S—.

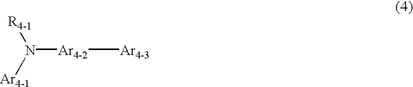

wherein Ar₄₋₁ and Ar₄₋₃ each is a substituted or unsubstituted aromatic group, and Ar₄₋₂ is a substituted or unsubstituted aromatic group. R₄₋₁ is a substituted or unsubstituted alkyl group, a substituted or unsubstituted aralkyl group, a substituted or unsubstituted vinyl group, or a substituted or unsubstituted aromatic group. R₄₋₁ and Ar₄₋₁ may form a ring directly or together with an organic group, such as —CH₂—, —CH₂CH₂—, —CH═CH—, —O—, or —S—.

In the formulae (2) to (4), examples of unsubstituted aromatic groups of R₂₋₁, Ar₂₋₁, R₃₋₁ to R₃₋₄, R₄₋₁, Ar₄₋₁ and Ar₄₋₃ include aryl groups, e.g., phenyl, naphthyl, anthracenyl and pyrenyl; aromatic heterocyclic groups, e.g., pyridyl, quinolyl, thienyl, furyl, carbazolyl, benzimidazolyl and benzothiazolyl. Examples of aromatic groups of Ar₂₋₂, Ar₂₋₃, Ar₃₋₁, Ar₃₋₂ and Ar₄₋₂ include divalent and trivalent residues (two or three hydrogen atoms are omitted) of aromatic compounds, such as benzene, naphthalene, anthracene and pyrene, and aromatic heterocyclic compounds, such as pyridine, quinoline, thiophene and furan. Examples of alkyl groups include methyl, ethyl, propyl, butyl and hexyl. Examples of aralkyl groups include benzyl, phenetyl, naphthylmethyl and furfuryl. Examples of substituent groups in these substituted groups include alkyl groups, e.g. methyl, ethyl, propyl, butyl and hexyl; alkoxy groups, e.g., methoxy, ethoxy and butoxy; halogen atoms, e.g., fluorine, chorine and bromine; aryl groups, e.g., phenyl and naphthyl; aromatic heterocyclic groups, e.g., pyridyl, quinolyl, thienyl and furyl; acyl groups, e.g., acetyl and benzyl; haloalkyl groups, e.g., trifluoromethyl; cyano groups; nitro groups; phenylcarbamoyl groups; carboxy groups; and hydroxy groups.

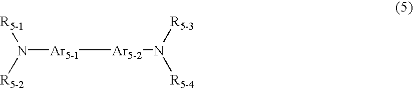

wherein Ar₅₋₁ and Ar₅₋₂ each is a substituted or unsubstituted aromatic group. R₅₋₁ to R₅₋₄ each is a substituted or unsubstituted alkyl group, a substituted or unsubstituted aralkyl group, a substituted or unsubstituted vinyl group, or a substituted or unsubstituted aromatic group, wherein at least two of R₅₋₁ to R₅₋₄ are the substituted or unsubstituted aromatic groups. R₅₋₁ and R₅₋₂ or R₅₋₃ and R₅₋₄ may form a ring directly or together with an organic group, such as —CH₂—, —CH₂CH₂—, —CH═CH—, —O—, or —S—.

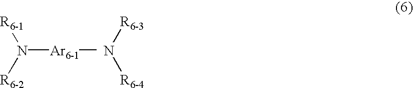

wherein Ar₆₋₁ is a substituted or unsubstituted aromatic group. R₆₋₁ to R₆₋₄ each is a substituted or unsubstituted alkyl group, a substituted or unsubstituted aralkyl group, a substituted or unsubstituted vinyl group, or a substituted or unsubstituted aromatic group, wherein at least two of R₆₋₁ to R₆₋₄ are the substituted or unsubstituted aromatic groups. R₆₋₁ and R₆₋₂ or R₆₋₃ and R₆₋₄ may form a ring directly or together with an organic group, such as —CH₂—, —CH₂CH₂—, —CH═CH—, —O—, or —S—.

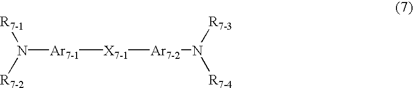

wherein Ar₇₋₁ and Ar₇₋₂ each is a substituted or unsubstituted aromatic group. R₇₋₁ to R₇₋₄ each is a substituted or unsubstituted alkyl group, a substituted or unsubstituted aralkyl group, a substituted or unsubstituted vinyl group, or a substituted or unsubstituted aromatic group, wherein at least two of R₇₋₁ to R₇₋₄ are the substituted or unsubstituted aromatic groups. R₇₋₁ and R₇₋₂ or R₇₋₃ and R₇₋₄ may form a ring directly or together with an organic group, such as —CH₂—, —CH₂CH₂—, —CH═CH—, —O—, or —S—. X₇₋₁ is a divalent organic group and preferably —CR₆R₇—(wherein R₆ and R₇ each is hydrogen, a substituted or unsubstituted alkyl group, a substituted or unsubstituted alkoxy group, a substituted or unsubstituted aralkyl group, a substituted or unsubstituted aromatic group wherein R₆ to R₇ may form a ring), —O—, —S—, —CH₂—O—CH₂—, —O—CH₂—O—, —NR₈—(wherein R₈ is a substituted or unsubstituted alkyl group or a substituted or unsubstituted aromatic group), or a substituted or unsubstituted arylene group.

In the formulae (5) to (7), examples of unsubstituted aromatic groups of R₅₋₁ to R₅₋₄, R₆₋₁ to R₆₋₄ and R₇₋₁ to R₇₋₄ include aryl groups, e.g., phenyl, naphthyl, anthracenyl and pyrenyl; aromatic heterocyclic groups, e.g., pyridyl, quinolyl, thienyl, furyl, carbazolyl, benzimidazolyl and benzothiazolyl. Examples of aromatic groups of Ar₅₋₁, Ar₅₋₂, Ar₆₋₁, Ar₇₋₁ and Ar₇₋₂ include divalent residues (two hydrogen atoms are omitted) of aromatic compounds, such as benzene, naphthalene, anthracene and pyrene, and aromatic heterocyclic compounds, such as pyridine, quinoline, thiophene and furan. Examples of alkyl groups include methyl, ethyl, propyl, butyl and hexyl. Examples of aralkyl groups include benzyl, phenetyl, naphthylmethyl and furfuryl. Examples of alkoxy groups include methoxy and ethoxy.

Examples of substituent groups in these substituted groups include alkyl groups, e.g., methyl, ethyl, propyl, butyl and hexyl; alkoxy groups, e.g., methoxy, ethoxy and butoxy; halogen atoms, e.g., fluorine, chorine and bromine; aryl groups, e.g., phenyl and naphthyl; aromatic heterocyclic groups, e.g., pyridyl, quinolyl, thienyl and furyl; acyl groups, e.g., acetyl and benzyl; haloalkyl groups, e.g., trifluoromethyl; cyano groups; nitro groups; phenylcarbamoyl groups; carboxy groups; and hydroxy groups.

The following are nonlimiting examples of preferable compounds represented by the formula (1), wherein Ar₁₋₁, Ar₁₋₂ and Ar_{1 3} in the formula (1) are shown.

| Compound No. | Ar₁₋₁ | Ar₁₋₂ | Ar₁₋₃ |
|---|---|---|---|
| 1-1 | 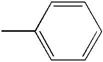 | 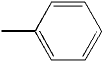 | 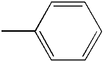 |
| 1-2 | 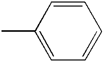 | 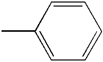 | 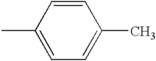 |
| 1-3 | 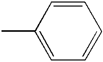 | 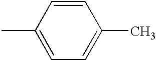 | 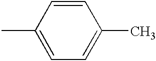 |
| 1-4 | 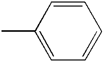 | 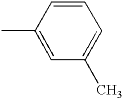 | 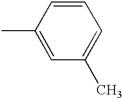 |
| 1-5 | 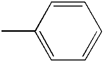 | 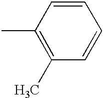 | 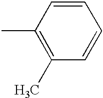 |
| 1-6 | 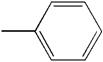 | 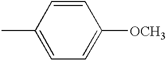 | 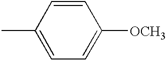 |
| 1-7 | 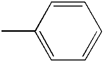 | 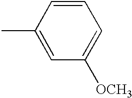 | 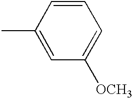 |
| 1-8 | 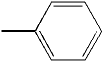 | 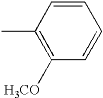 | 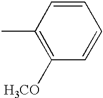 |
| 1-9 | 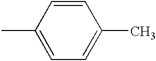 | 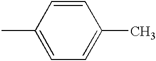 | 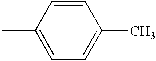 |
| 1-10 | 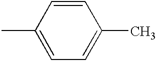 | 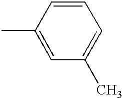 | 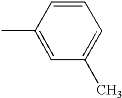 |
| 1-11 | 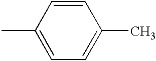 | 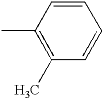 | 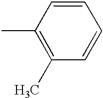 |
| 1-12 | 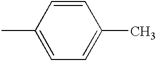 | 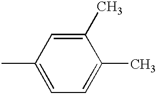 | 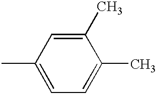 |
| 1-13 | 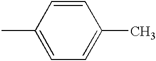 | 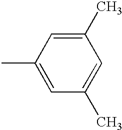 | 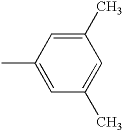 |
| 1-14 | 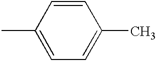 | 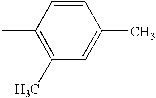 | 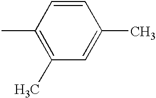 |
| 1-15 | 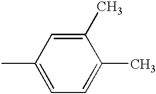 | 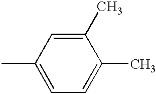 | 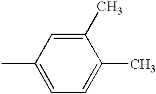 |
| 1-16 | 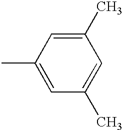 | 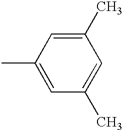 | 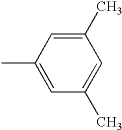 |
| 1-17 | 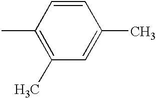 | 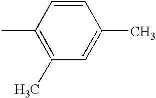 | 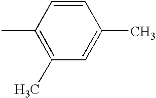 |
| 1-18 | 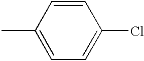 | 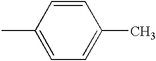 | 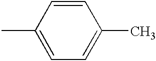 |
| 1-19 | 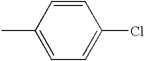 | 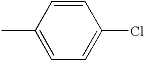 | 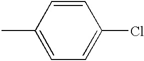 |
| 1-20 | 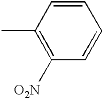 | 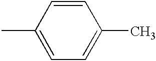 | 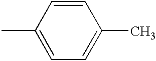 |
| 1-21 | 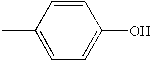 | 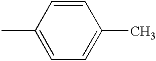 | 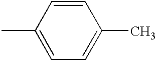 |
| 1-22 | 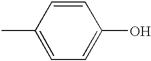 | 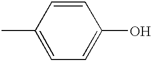 | 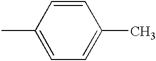 |
| 1-23 | 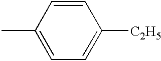 | 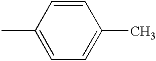 | 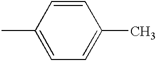 |
| 1-24 | 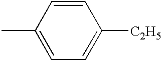 | 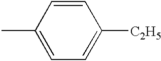 | 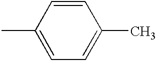 |
| 1-25 | 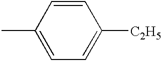 | 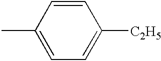 | 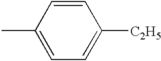 |
| 1-26 | 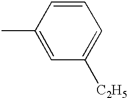 | 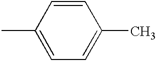 | 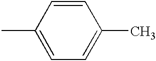 |
| 1-27 | 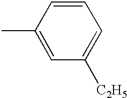 | 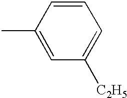 | 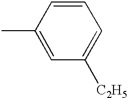 |
| 1-28 | 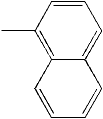 | 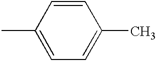 | 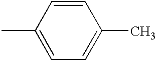 |
| 1-29 | 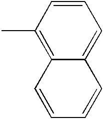 | 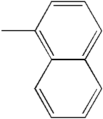 | 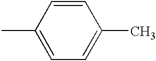 |
| 1-30 | 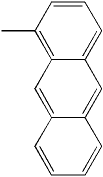 | 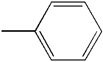 | 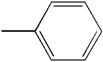 |
| 1-31 | 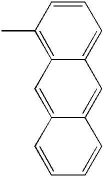 | 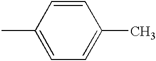 | 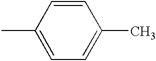 |
| 1-32 | 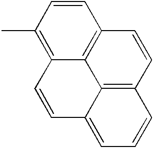 | 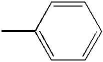 | 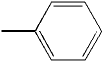 |
| 1-33 | 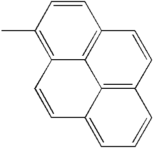 | 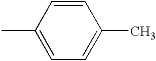 | 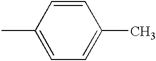 |
| 1-34 | 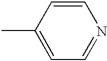 | 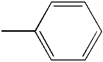 | 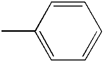 |
| 1-35 | 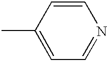 | 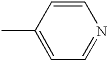 | 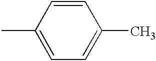 |
| 1-36 | 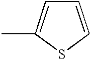 | 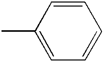 | 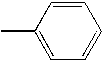 |
| 1-37 | 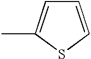 | 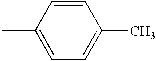 | 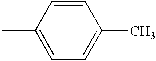 |
| 1-38 | 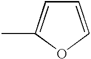 | 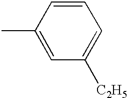 | 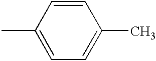 |
| 1-39 | 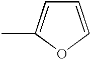 | 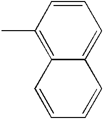 | 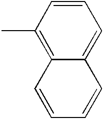 |
| 1-40 | 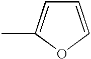 | 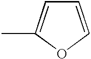 | 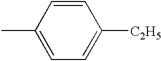 |
| 1-41 | 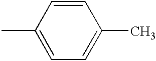 | 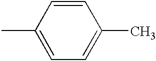 | 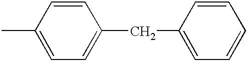 |
| 1-42 | 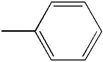 | 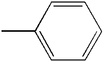 | 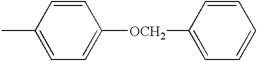 |
| 1-43 | 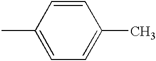 | 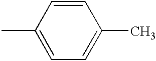 | 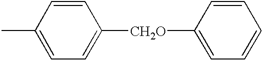 |
| 1-44 | 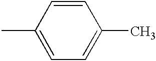 | 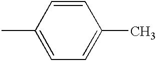 | 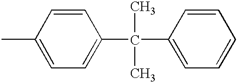 |
| 1-45 | 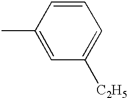 | 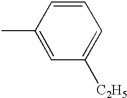 | 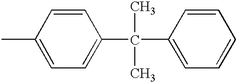 |
| 1-46 | 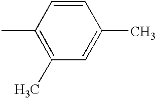 | 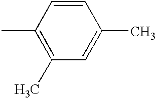 | 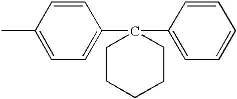 |
| 1-47 | 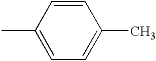 | 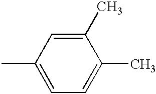 | 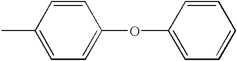 |
| 1-48 | 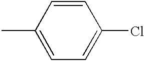 | 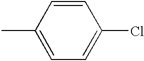 | 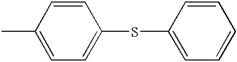 |
| 1-49 | 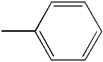 | 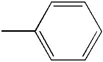 | 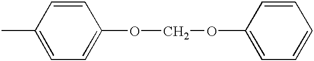 |
| 1-50 | 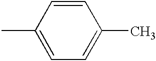 | 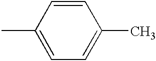 | 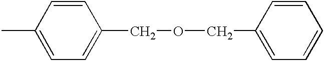 |

The following are nonlimiting examples of preferable compounds represented by the formulae (2), (3) and (4).

| Compound | Formula |
|---|---|
| 2-1 | 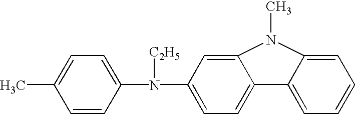 |
| 2-2 | 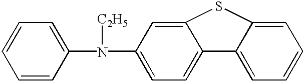 |
| 2-3 | 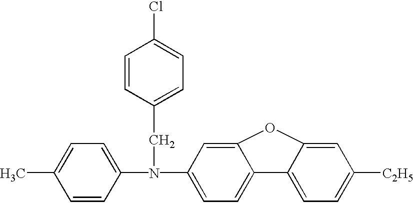 |
| 2-4 | 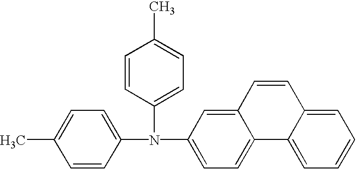 |
| 2-5 | 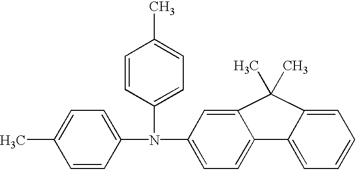 |
| 2-6 | 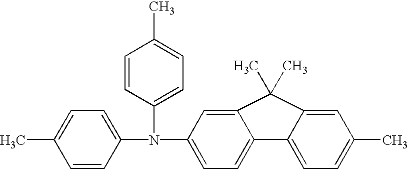 |
| 2-7 | 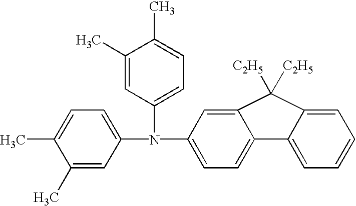 |
| 2-8 | 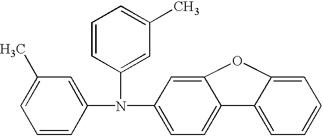 |
| 2-9 | 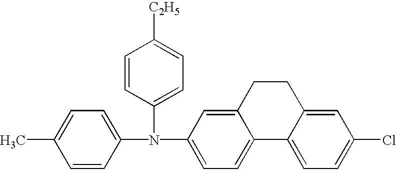 |
| 2-10 | 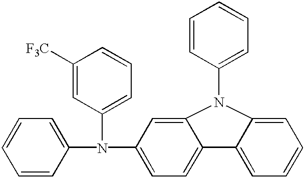 |
| 2-11 | 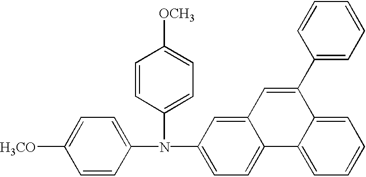 |
| 2-12 | 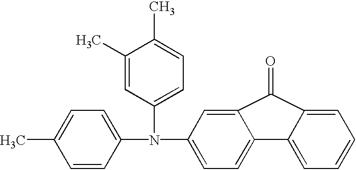 |
| 2-13 | 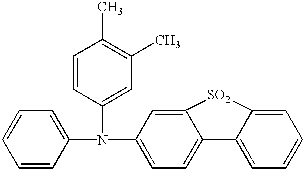 |
| 2-14 | 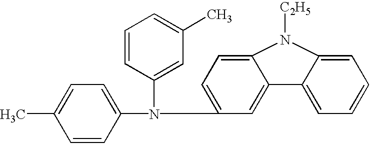 |
| 2-15 | 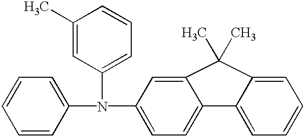 |
| 2-16 | 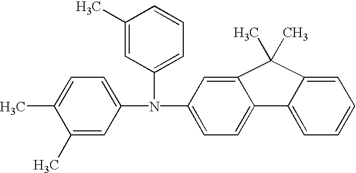 |
| 2-17 | 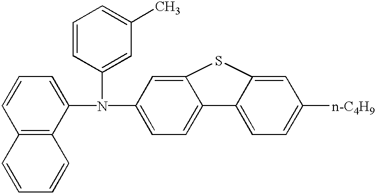 |
| 2-18 | 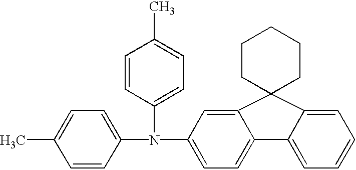 |
| 2-19 | 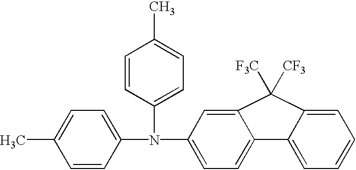 |
| 2-20 | 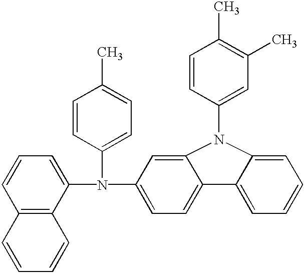 |
| 2-21 | 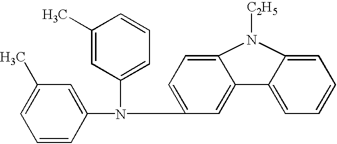 |
| 2-22 | 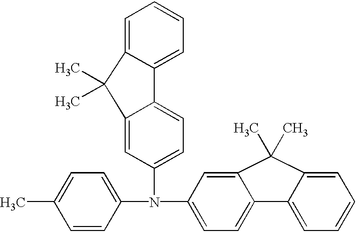 |
| 2-23 | 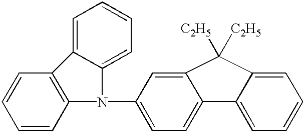 |
| 2-24 | 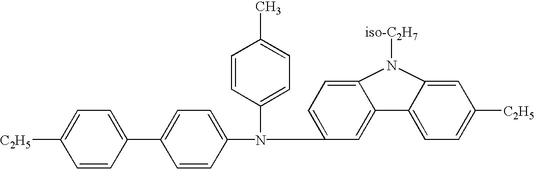 |
| 2-25 | 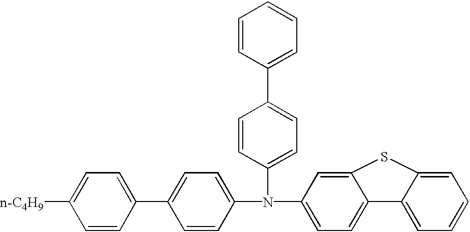 |
| 2-26 | 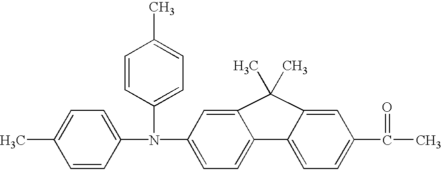 |
| 2-27 | 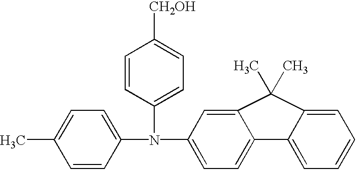 |
| 2-28 | 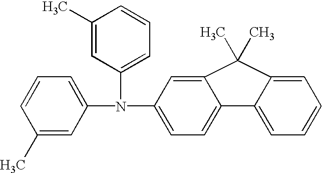 |
| 3-1 | 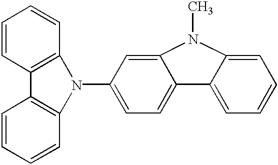 |
| 3-2 | 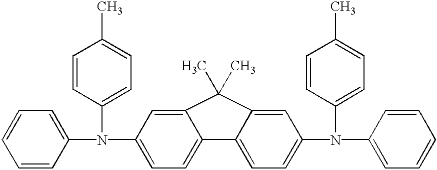 |
| 3-3 | 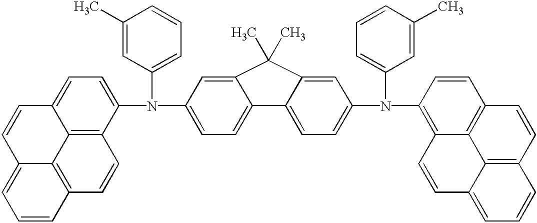 |
| 3-4 | 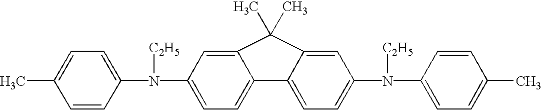 |
| 3-5 | 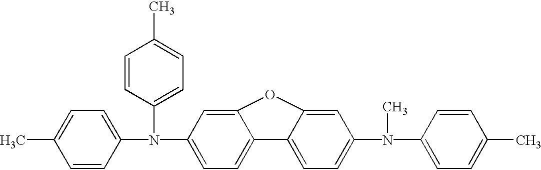 |
| 3-6 | 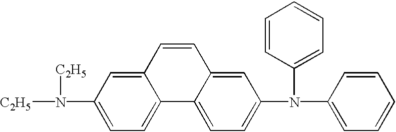 |
| 3-7 | 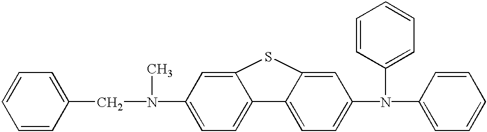 |
| 3-8 | 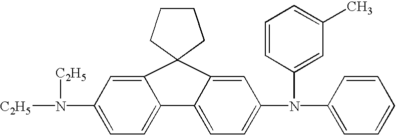 |
| 3-9 | 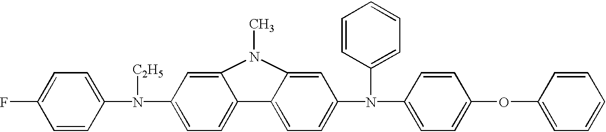 |
| 3-10 | 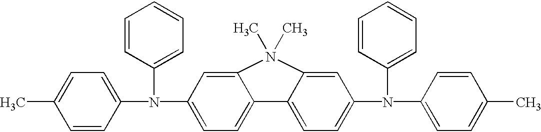 |
| 3-11 | 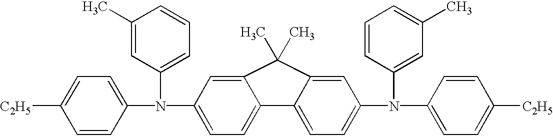 |
| 3-12 | 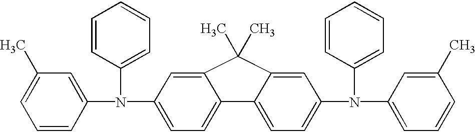 |
| 3-13 | 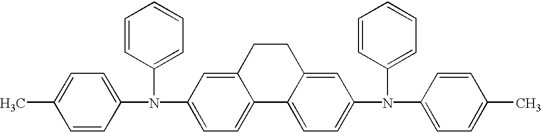 |
| 3-14 | 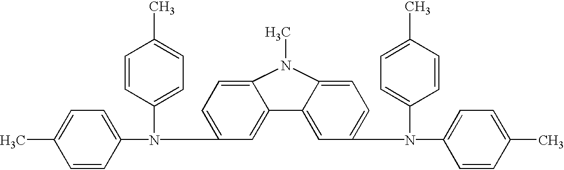 |
| 3-15 | 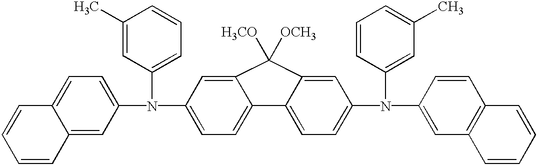 |
| 3-16 | 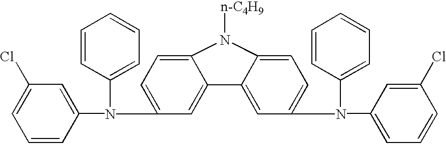 |
| 3-17 | 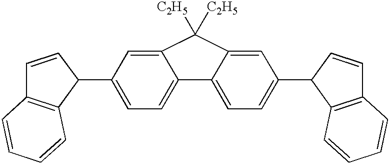 |
| 3-18 | 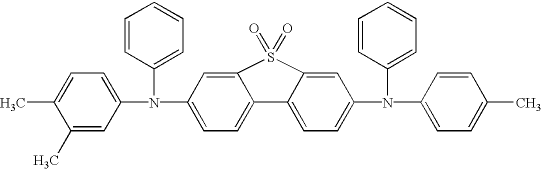 |
| 3-19 | 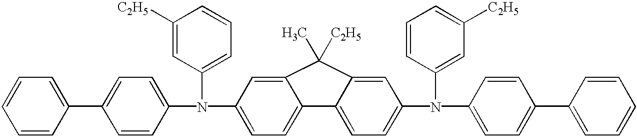 |
| 3-20 | 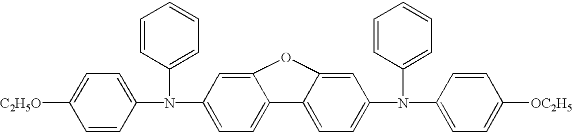 |
| 3-21 | 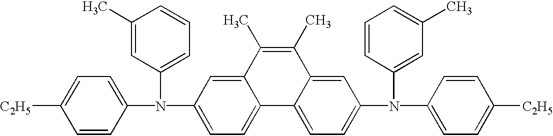 |
| 3-22 | 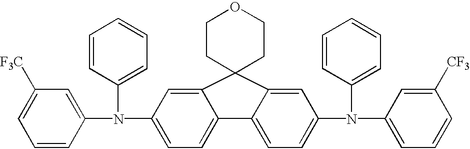 |
| 3-23 | 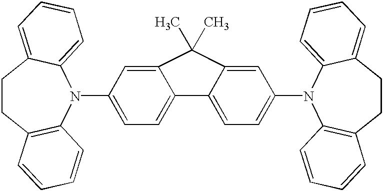 |
| 3-24 | 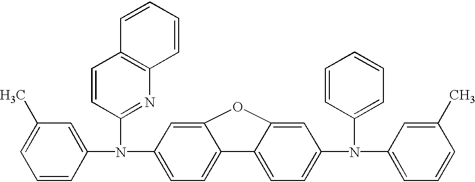 |
| 3-25 | 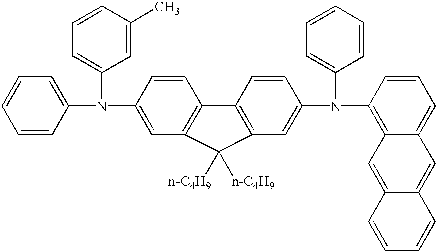 |
| 3-26 | 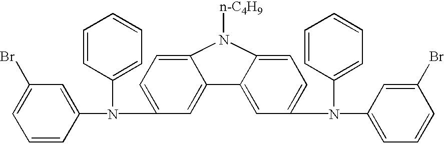 |
| 3-27 | 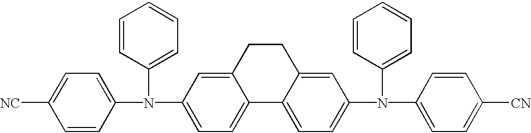 |
| 3-28 | 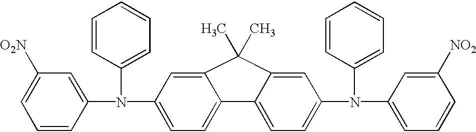 |
| 4-1 | 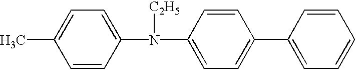 |
| 4-2 | 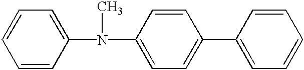 |
| 4-3 | 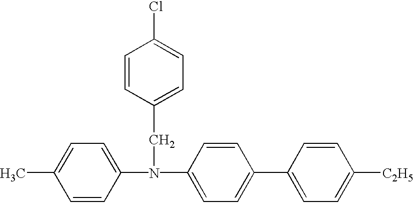 |
| 4-4 | 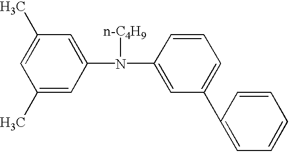 |
| 4-5 | 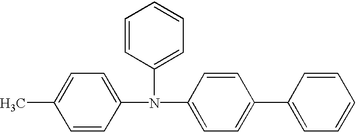 |
| 4-6 | 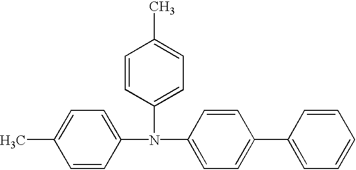 |
| 4-7 | 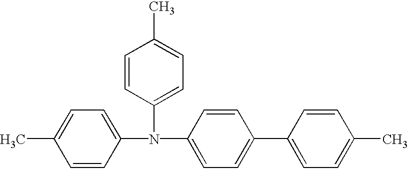 |
| 4-8 | 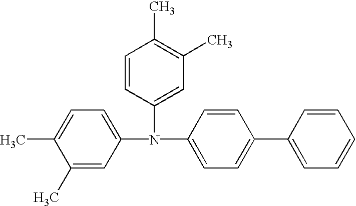 |
| 4-9 | 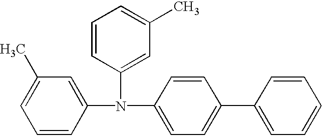 |
| 4-10 | 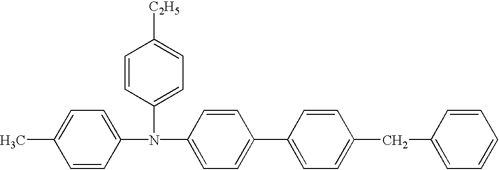 |
| 4-11 | 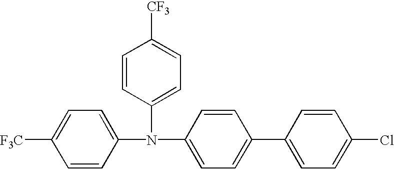 |
| 4-12 | 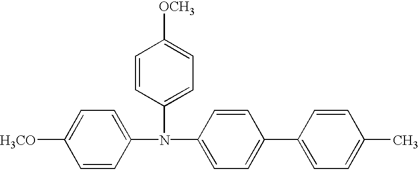 |
| 4-13 | 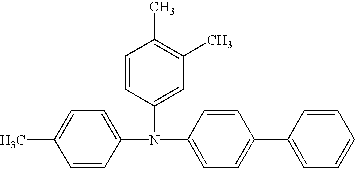 |
| 4-14 | 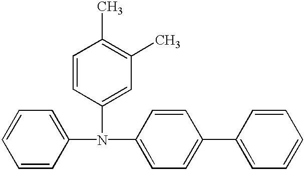 |
| 4-15 | 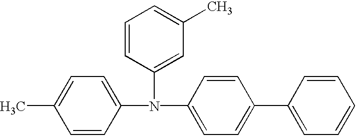 |
| 4-16 | 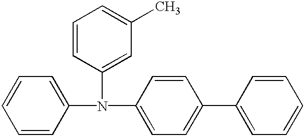 |
| 4-17 | 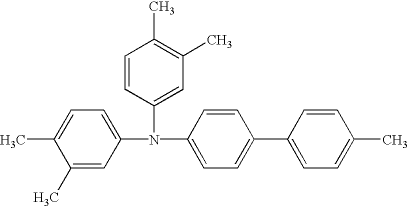 |
| 4-18 | 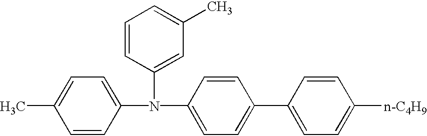 |
| 4-19 | 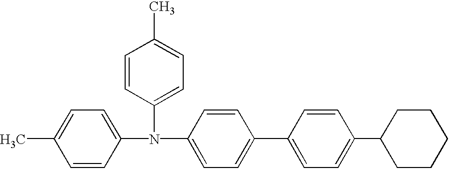 |
| 4-20 | 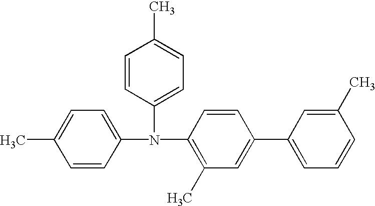 |
| 4-21 | 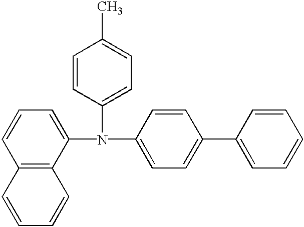 |
| 4-22 | 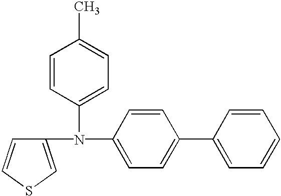 |
| 4-23 | 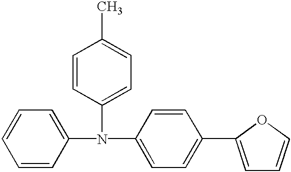 |
| 4-24 | 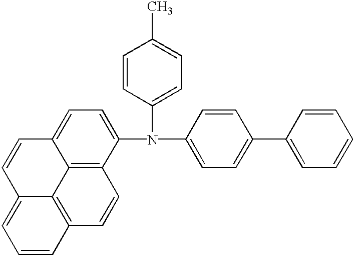 |
| 4-25 | 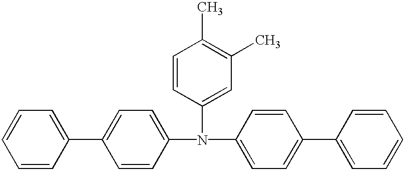 |
| 4-26 | 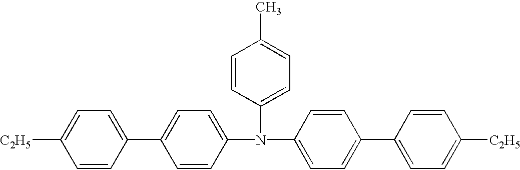 |
| 4-27 | 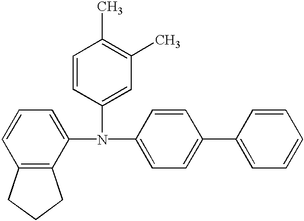 |
| 4-28 | 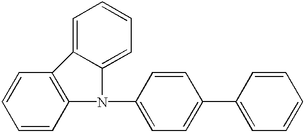 |
| 4-29 | 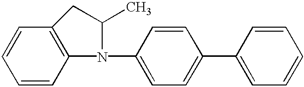 |
| 4-30 | 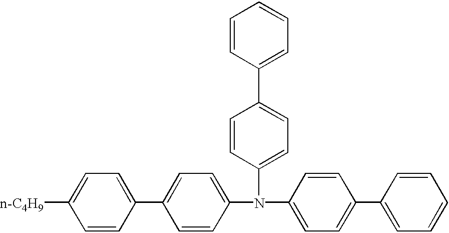 |
| 4-31 | 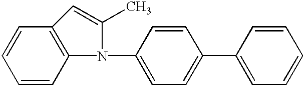 |
| 4-32 | 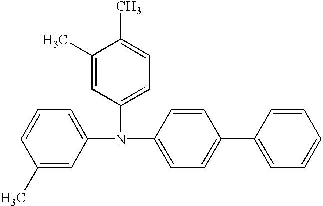 |

The following are nonlimiting examples of preferable compounds represented by the formulae (5), (6) and (7), wherein A and B in Compounds 6-1 to 6-56 represent and

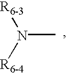

respectively in the formula (6).

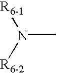

| Compound | Formula |
|---|---|
| 5-1 | 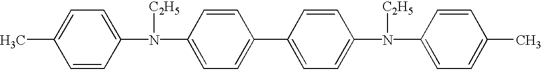 |
| 5-2 | 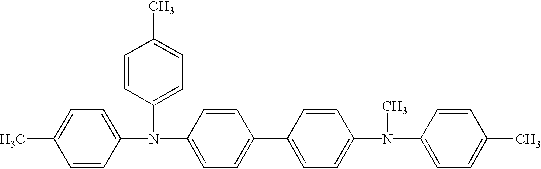 |
| 5-3 | 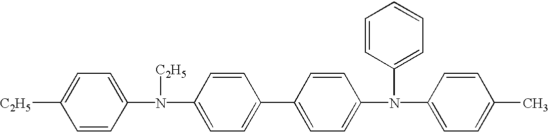 |
| 5-4 | 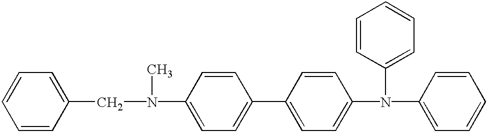 |
| 5-5 | 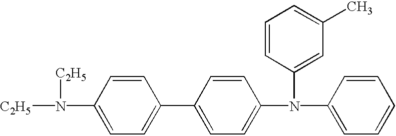 |
| 5-6 | 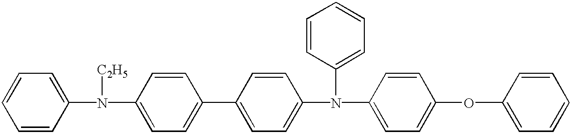 |
| 5-7 | 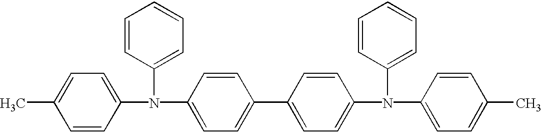 |
| 5-8 | 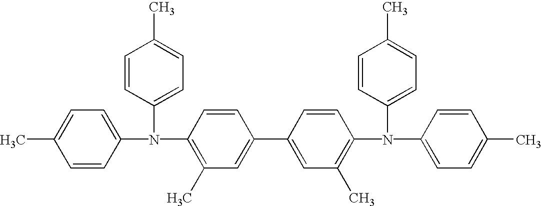 |
| 5-9 | 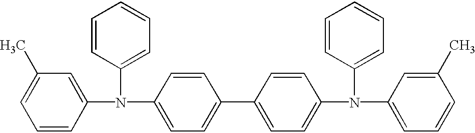 |
| 5-10 | 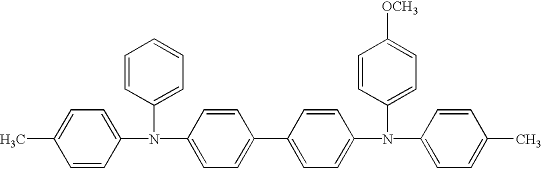 |
| 5-11 | 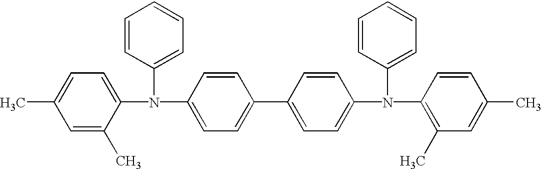 |
| 5-12 | 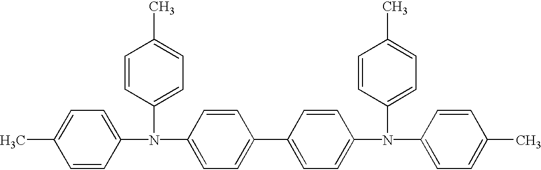 |
| 5-13 | 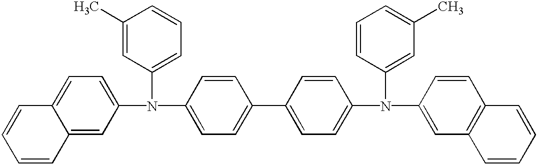 |
| 5-14 | 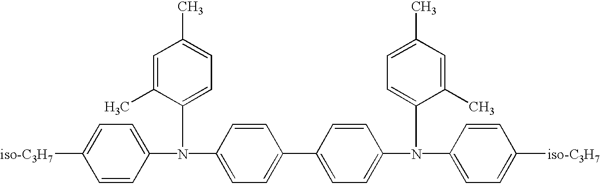 |
| 5-15 | 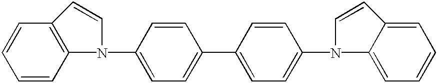 |
| 5-16 | 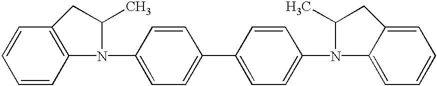 |
| 5-17 | 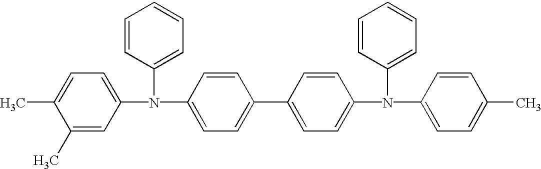 |
| 5-18 | 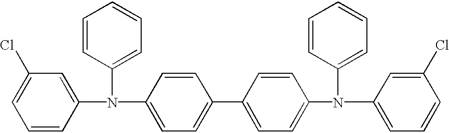 |
| 5-19 | 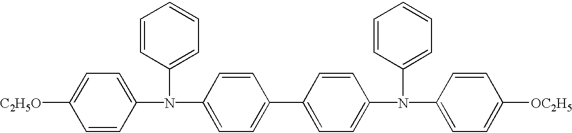 |
| 5-20 | 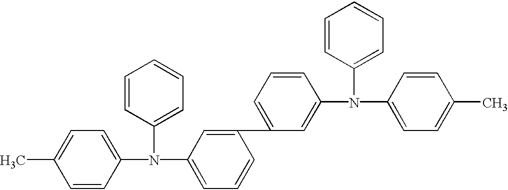 |
| 5-21 | 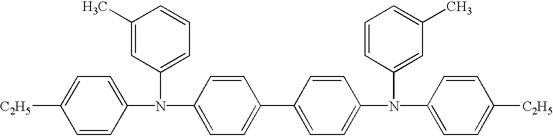 |
| 5-22 | 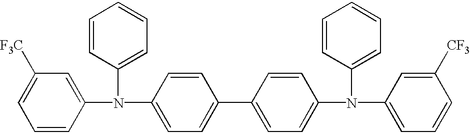 |
| 5-23 | 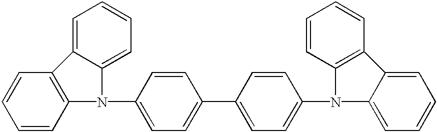 |
| 5-24 | 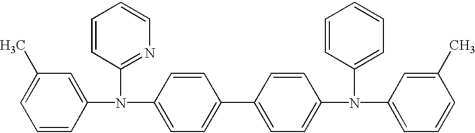 |
| 5-25 | 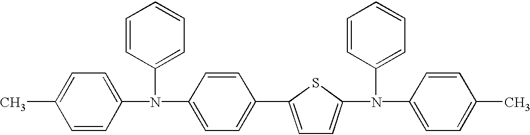 |
| 5-26 | 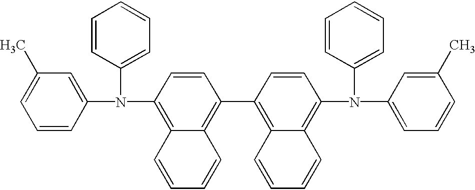 |
| 5-27 | 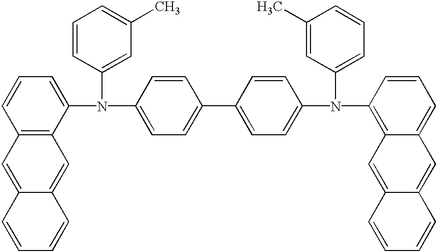 |
| 5-28 | 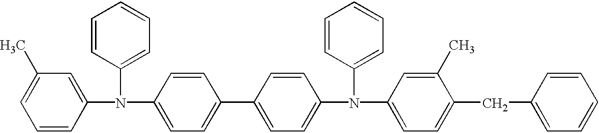 |
| 5-29 | 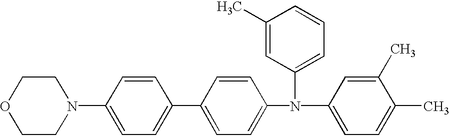 |
| 5-30 | 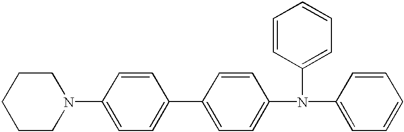 |
| 5-31 | 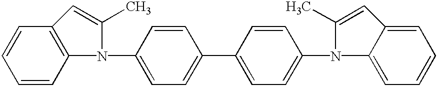 |

| Compound | Ar₆₋₁ | A | B |
|---|---|---|---|
| 6-1 | 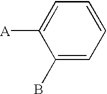 | 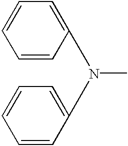 | 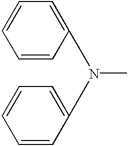 |
| 6-2 | 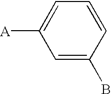 | 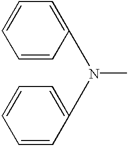 | 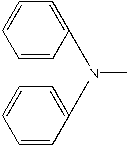 |
| 6-3 | 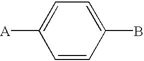 | 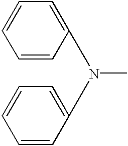 | 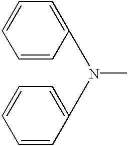 |
| 6-4 | 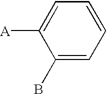 | 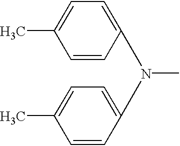 | 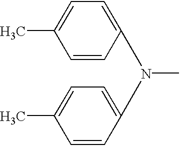 |
| 6-5 | 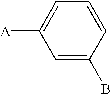 | 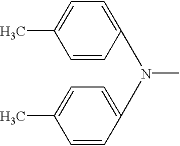 | 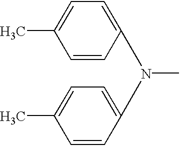 |
| 6-6 | 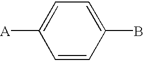 | 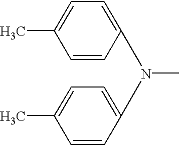 | 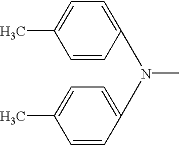 |
| 6-7 | 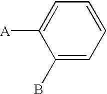 | 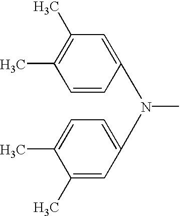 | 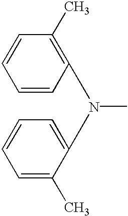 |
| 6-8 | 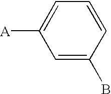 | 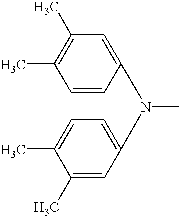 | 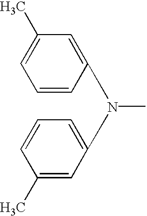 |
| 6-9 | 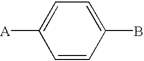 | 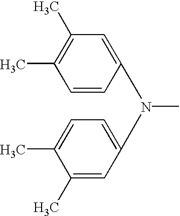 | 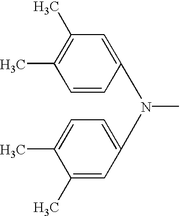 |
| 6-10 | 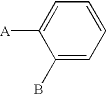 | 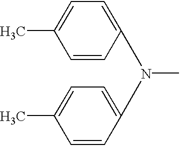 | 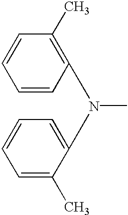 |
| 6-11 | 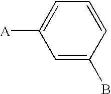 | 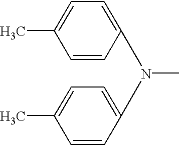 | 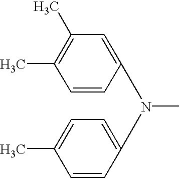 |
| 6-12 | 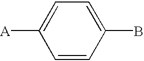 | 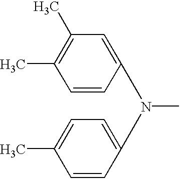 | 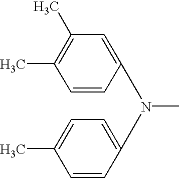 |
| 6-13 | 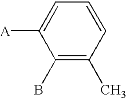 | 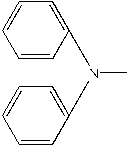 | 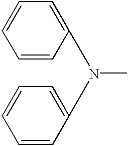 |
| 6-14 | 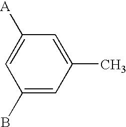 | 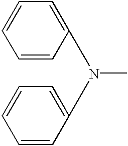 | 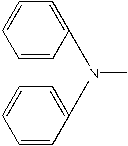 |
| 6-15 | 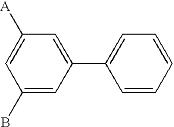 | 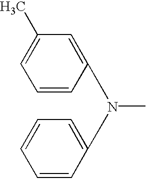 | 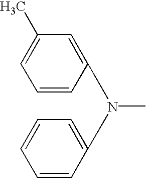 |
| 6-16 | 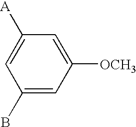 | 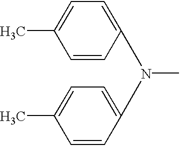 | 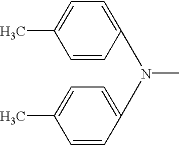 |
| 6-17 | 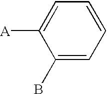 | 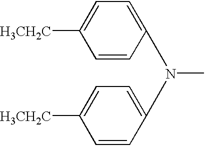 | 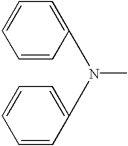 |
| 6-18 | 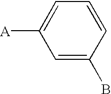 | 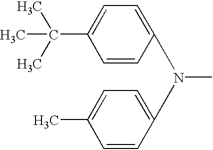 | 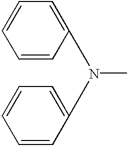 |
| 6-19 | 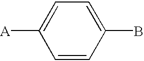 | 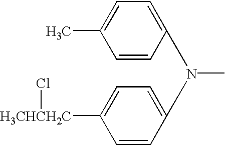 | 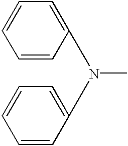 |
| 6-20 | 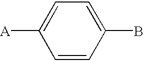 | 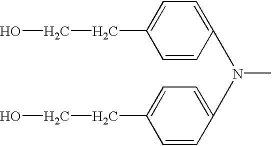 | 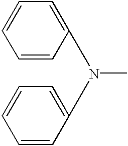 |
| 6-21 | 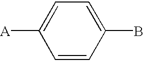 | 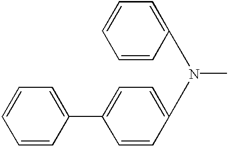 | 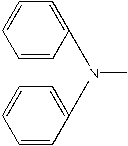 |
| 6-22 | 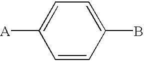 | 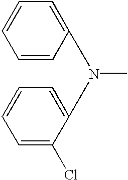 | 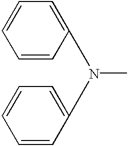 |
| 6-23 | 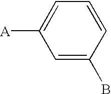 | 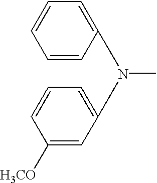 | 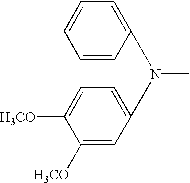 |
| 6-24 | 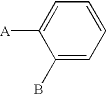 | 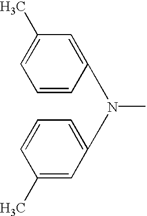 | 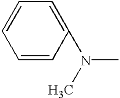 |
| 6-25 | 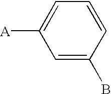 | 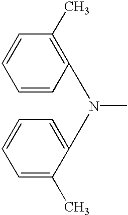 | 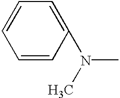 |
| 6-26 | 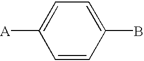 | 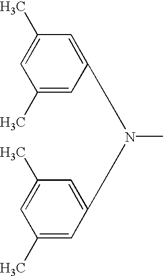 | 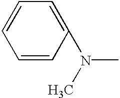 |
| 6-27 | 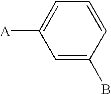 | 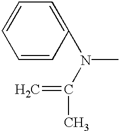 | 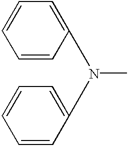 |
| 6-28 | 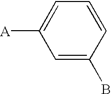 | 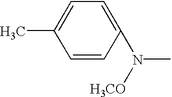 | 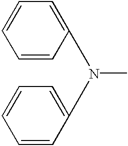 |
| 6-29 | 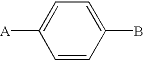 | 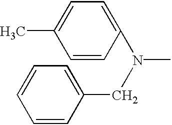 | 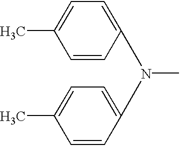 |
| 6-30 | 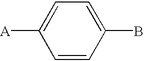 | 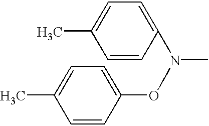 | 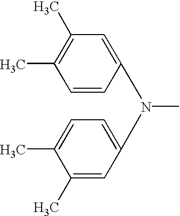 |
| 6-31 | 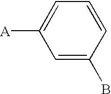 | 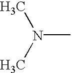 | 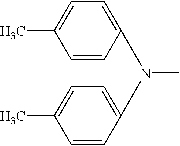 |
| 6-32 | 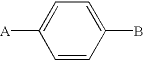 | 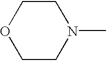 | 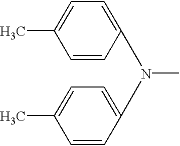 |
| 6-33 | 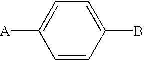 | 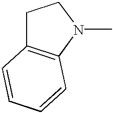 | 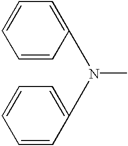 |
| 6-34 | 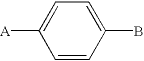 | 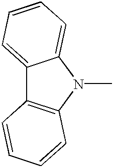 | 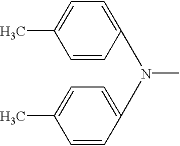 |
| 6-35 | 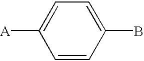 | 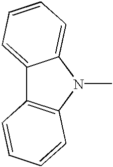 | 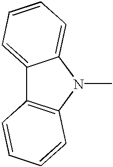 |
| 6-36 | 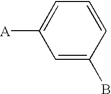 | 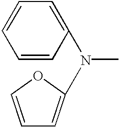 | 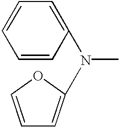 |
| 6-37 | 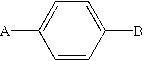 | 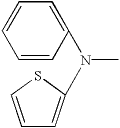 | 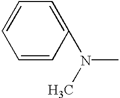 |
| 6-38 | 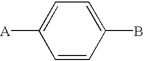 | 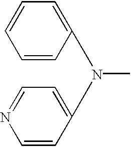 | 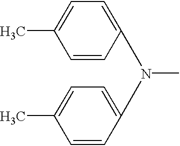 |
| 6-39 | 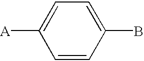 | 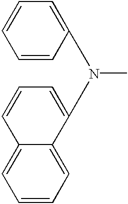 | 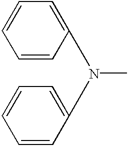 |
| 6-40 | 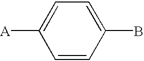 | 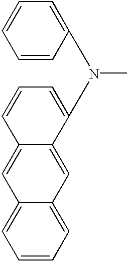 | 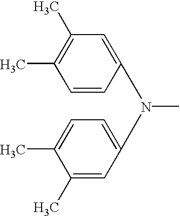 |
| 6-41 | 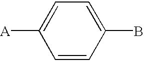 | 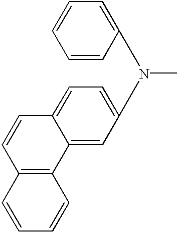 | 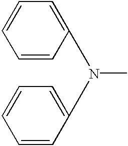 |
| 6-42 | 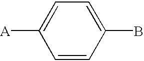 | 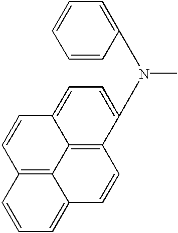 | 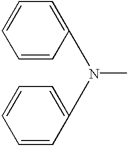 |
| 6-43 | 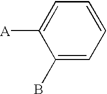 | 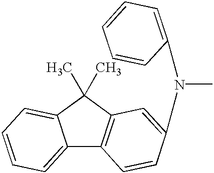 | 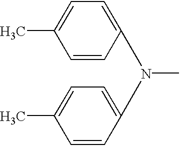 |
| 6-44 | 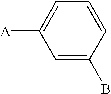 | 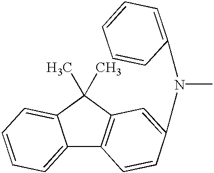 | 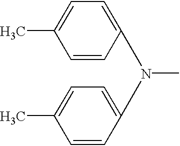 |
| 6-45 | 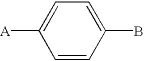 | 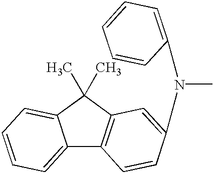 | 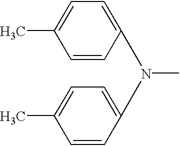 |
| 6-46 | 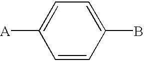 | 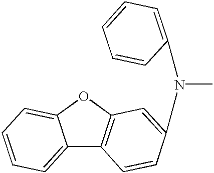 | 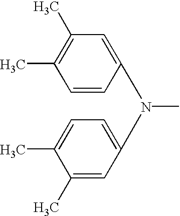 |
| 6-47 | 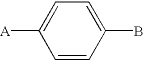 | 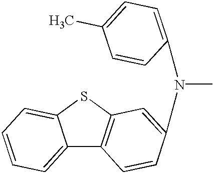 | 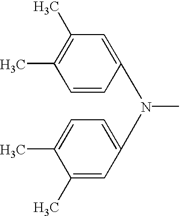 |
| 6-48 | 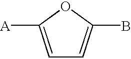 | 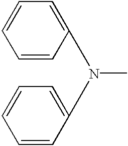 | 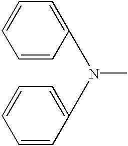 |
| 6-49 | 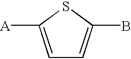 | 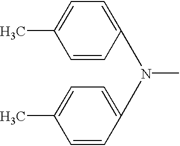 | 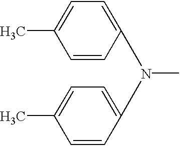 |
| 6-50 | 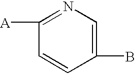 | 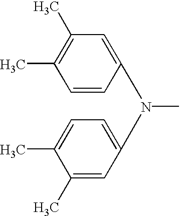 | 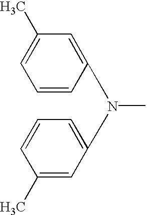 |
| 6-51 | 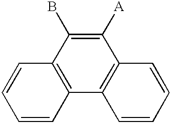 | 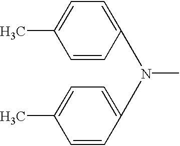 | 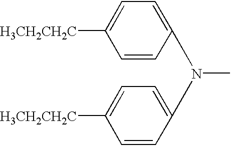 |
| 6-52 | 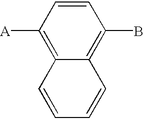 | 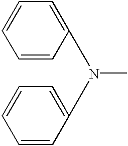 | 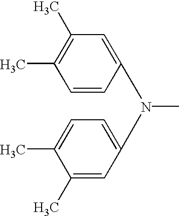 |
| 6-53 | 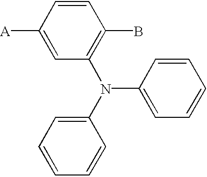 | 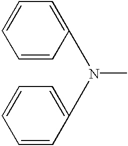 | 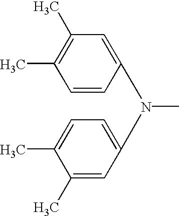 |
| 6-54 | 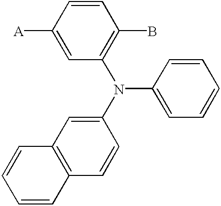 | 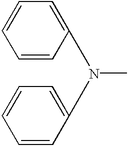 | 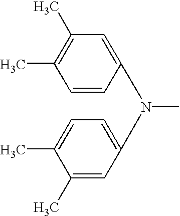 |
| 6-55 | 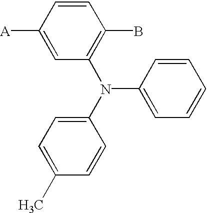 | 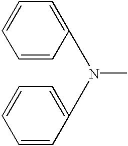 | 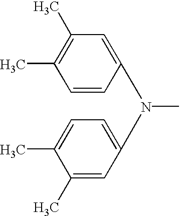 |
| 6-56 | 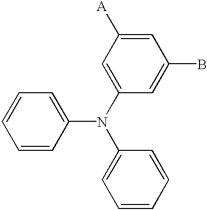 | 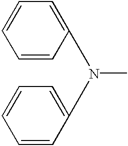 | 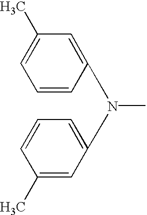 |

| Compound | Formula |
|---|---|
| 7-1 | 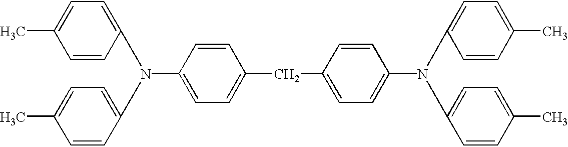 |
| 7-2 | 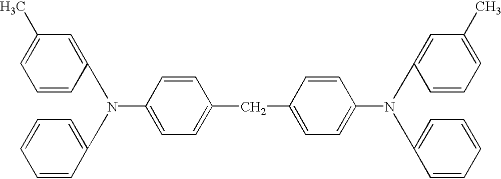 |
| 7-3 | 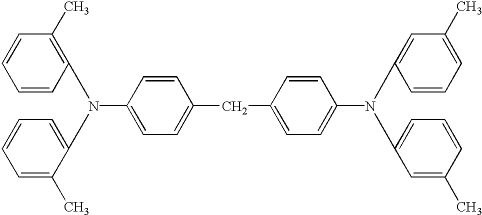 |
| 7-4 | 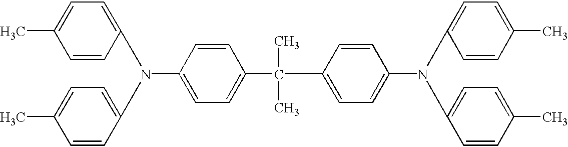 |
| 7-5 | 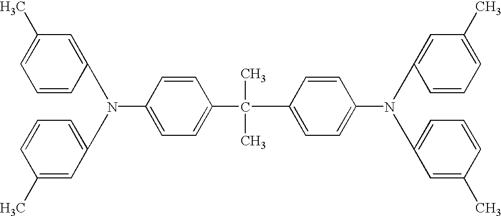 |
| 7-6 | 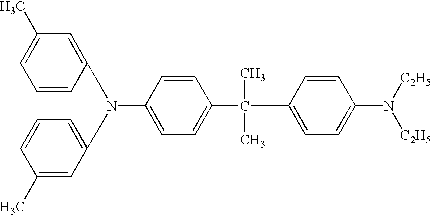 |
| 7-7 | 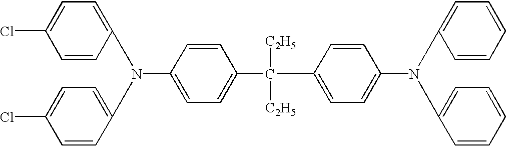 |
| 7-8 | 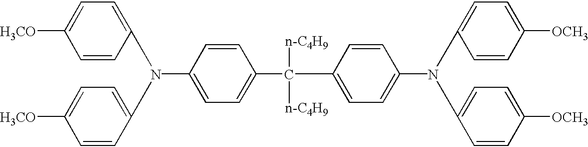 |
| 7-9 | 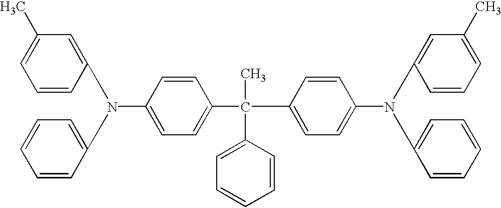 |
| 7-10 | 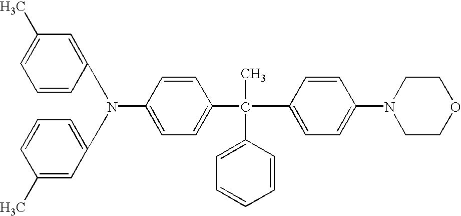 |
| 7-11 | 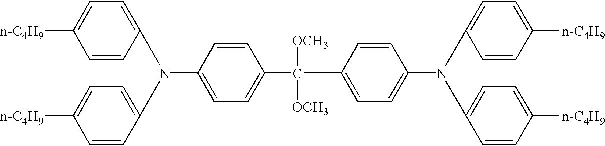 |
| 7-12 | 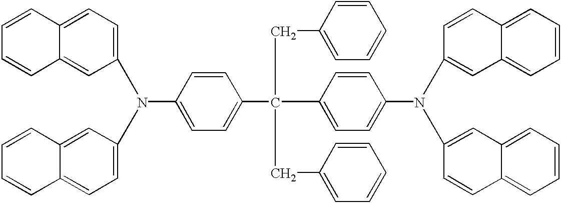 |
| 7-13 | 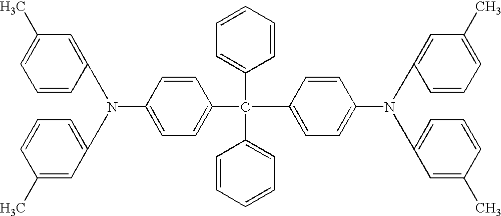 |
| 7-14 | 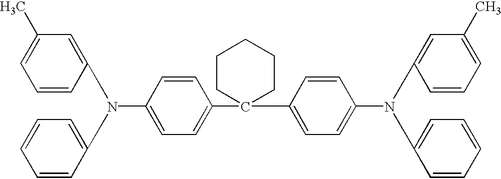 |
| 7-15 | 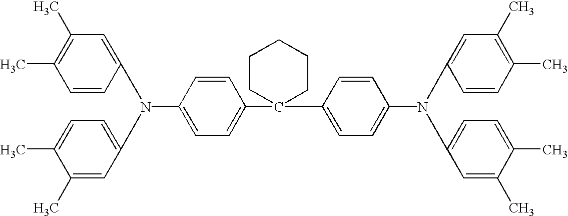 |
| 7-16 | 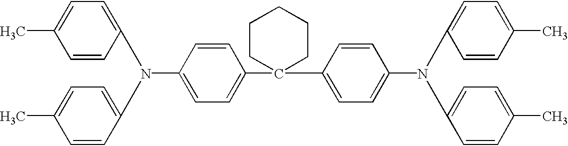 |
| 7-17 | 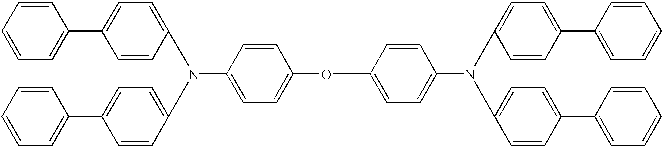 |
| 7-18 | 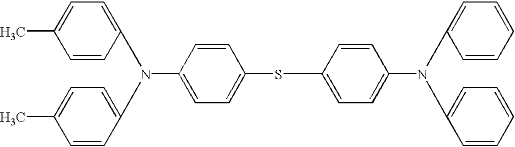 |
| 7-19 | 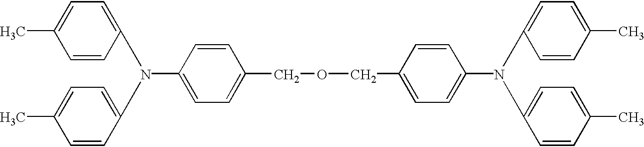 |
| 7-20 | 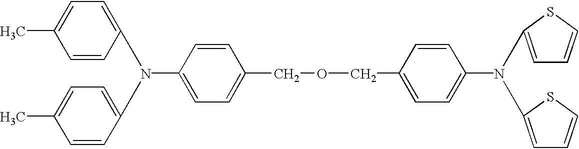 |
| 7-21 | 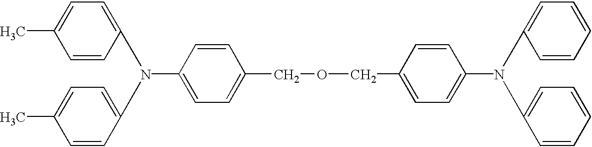 |
| 7-22 | 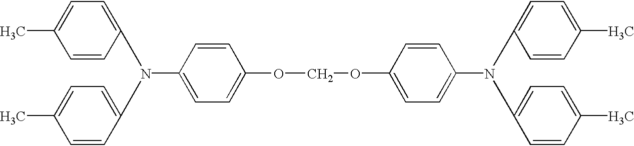 |
| 7-23 | 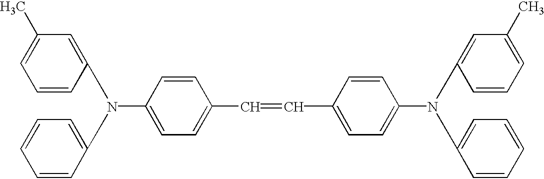 |
| 7-24 | 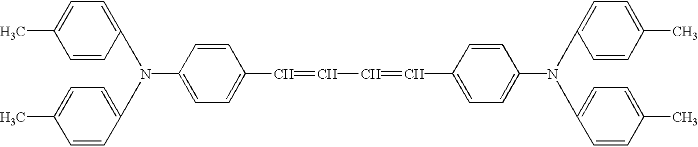 |
| 7-25 | 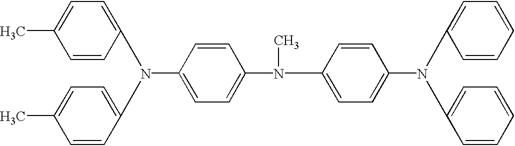 |
| 7-26 | 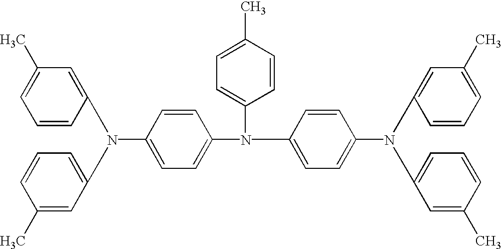 |
| 7-27 | 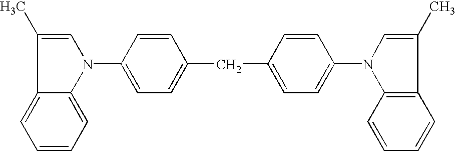 |
| 7-28 | 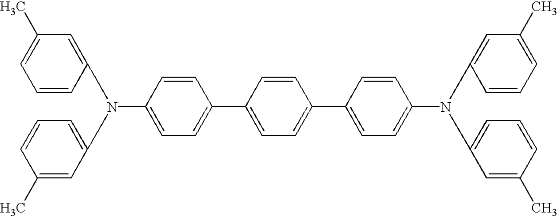 |
| 7-29 | 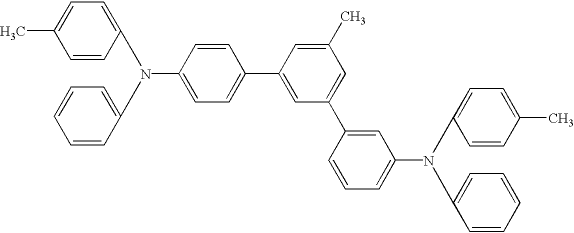 |
| 7-30 | 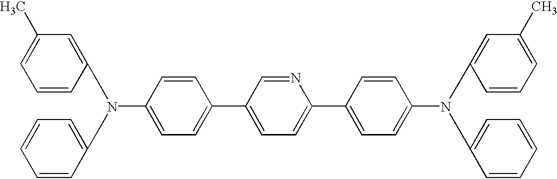 |
| 7-31 | 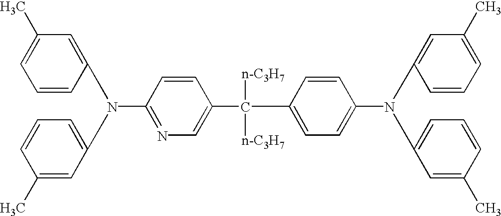 |
| 7-32 | 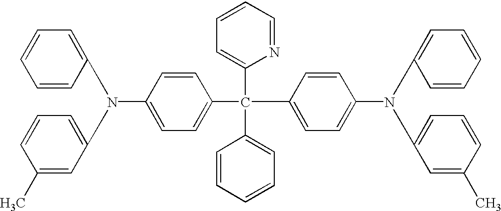 |
| 7-33 | 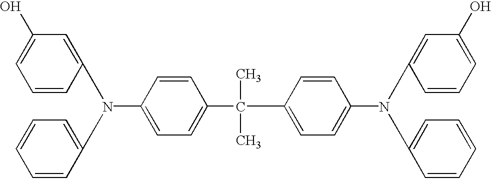 |

The charge transfer material is preferably compounded in an amount of 10 to 500 parts by weight to 100 parts by weight of the binder. The charge transport layer is electrically conducted to the charge-generating layer, receives carriers injected from the charge-generating layer under an electric field, and transports the carriers to the surface. The thickness of the charge transport layer is in a range of preferably 5 μm to 40 μm and more preferably 10 μm to 30 μm, in consideration of transportability of charged carriers.

The charge transport layer may contain antioxidant, UV absorbent and plasticizers, if necessary.

Materials for the underlying layer optionally formed in the present invention includes casein, polyvinyl alcohol, nitrocellulose, polyamide, e.g., nylon-6, nylon-6,6, nylon-10, and compolymeric nylon, polyurethanes, and aluminum oxide. The thickness of the underlying layer is in a range of preferably 0.1 μm to 10 μm and more preferably 0.5 to 5 μm.

The protective layer optionally formed on the photosensitive layer in the present invention may be a resinous layer. The resinous layer may contain conductive particles.

These layers may be formed by any coating process using a solvent. Examples of the coating processes include a dip coating process, a spray coating process, a spin coating process, a roller coating process, a Meyer bar coating process, and a blade coating process.

The exposure means in the present invention preferably has a semiconductor laser having an oscillation wavelength of 380 nm to 500 nm as an exposure light source. Other configurations are not limited in the present invention. It is more preferable in view of a wide variety of selectivity of charge transfer materials and facility cost that the oscillation wavelength be in a range of 400 nm to 450 nm.

In the present invention, any charging means, any developing means, any transfer means and any cleaning means may be employed without restrictions.

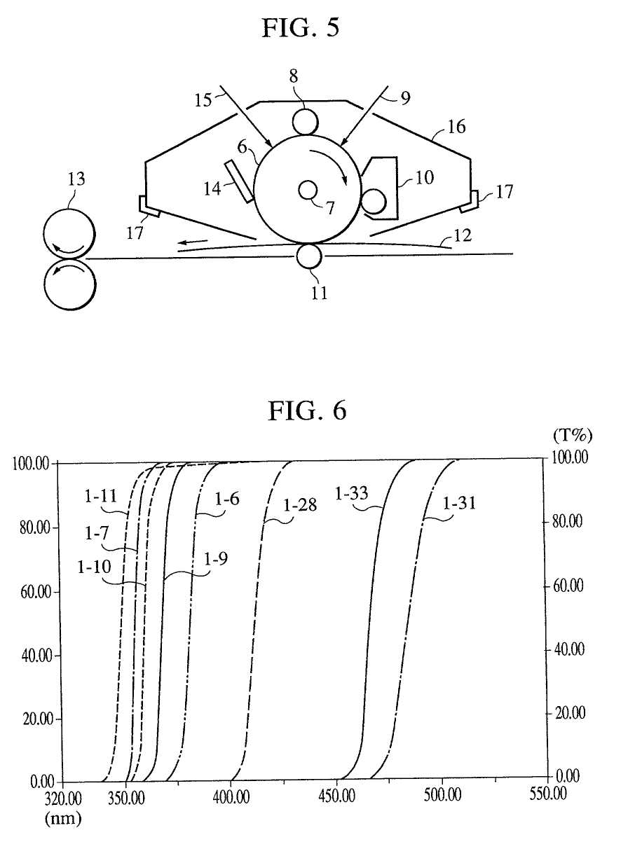

FIG. 5 is a schematic cross-sectional view of an electrophotographic apparatus having a process cartridge provided with the photosensitive member of the present invention. A drum electrophotographic photosensitive member 6 turns on an axis 7 in the direction of the arrow in the drawing. The photosensitive member 6 is uniformly charged to a given negative or positive potential by a primary charging means 8, and is then exposed by exposure light 9 from an exposure means (not shown in the drawing) by, for example, laser beam scanning. A latent image is formed on the surface of the photosensitive member 6 sequentially.

The latent image is developed by a develop means 10 with toner, and the developed toner image on the photosensitive member 6 is transferred onto a recording sheet 12 fed from a feeder (not shown in the drawing) to a gap between the photosensitive member 6 and a transfer means 11 in synchronism with the rotation of the photosensitive member 6.

The recording sheet 12 is detached from the photosensitive member 6, is introduced to a fixing means 13 to fix the transferred image and is discharged from the apparatus. The residual toner on the surface of the photosensitive member 6 is removed after the transfer by a cleaning means 14. The surface of the photosensitive member 6 is deelectrified and then is used in the subsequent image formation. Since the primary charging means 8 in the drawing is a contact-type charging means using a charging roller, preliminary exposure is not always necessary.

In the present invention, at least two components among the electrophotographic photosensitive member 6, the primary charging means 8, the developing means 10 and the cleaning means 14 may be integrally combined as a process cartridge which is attachable to and detachable from an electrophotographic apparatus body, such as a copying machine or a laser beam printer. For example, a process cartridge 16 includes the photosensitive member 6 and at least one of the components of the primary charging means 8, the developing means 10 and the cleaning means 14, and is attachable to and detachable from the apparatus body by a guide means such as a rail 17.

The present invention will now be described in more detail with reference to the following Examples. In the Examples, “parts” means parts by weight.

### EXAMPLE 1

<Preparation of Electrophotographic Photosensitive Member>

A coating solution of 5.5 parts of N-methoxylated nylon-6 (weight average molecular weight: 30,000) and 8 parts of alcohol-soluble copolymeric nylon (weight average molecular weight: 28,000) in a mixed solvent of 30 parts of methanol and 80 parts of butanol was coated on an aluminum substrate using a Meyer bar, and was then dried to form an underlying layer having a thickness of approximately 1 μm.

To 400 parts of tetrahydrofuran was added 20 parts of an azo compound represented by the following formula and 10 parts of a butyral resin (butyral content: 65 mole percent, weight average molecular weight: 30,000), and the mixture was dispersed in a sand mill with 1-mm diameter glass beads for 20 hours. The dispersion was coated on the underlying layer using a Meyer bar, and dried to form a charge-generating layer having a thickness of approximately 0.4 μm.

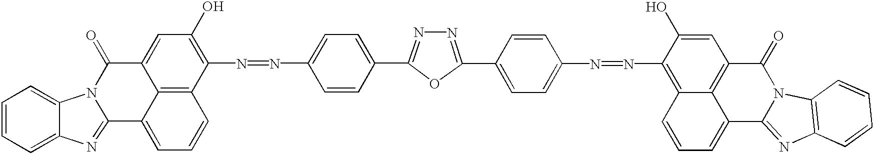

A charge transport layer solution was prepared by dissolving 7 parts of Compound 1-6 and 10 parts of bisphenol-Z type polycarbonate (weight average molecular weight: 45,000) in 60 parts of monochlorobenzene. The solution was coated on the charge-generating layer using a Meyer bar, and dried at 100° C. for one hour to form a charge transport layer having a thickness of approximately 23 μm. An electrophotographic photosensitive member was thereby formed.

<Measurement of Electrophotographic Characteristics>

The electrophotographic characteristics of the resulting photosensitive member were measured using an electrostatic copying sheet tester EPA-8100 made by Kawaguchi Electric Co., Ltd.

(Initial Characteristics)

The photosensitive member was charged to a surface potential of −600 volts using a Corona charger, and was exposed with a monochromatic light beam of 380 nm from a monochromator. The dose when the surface potential is decreased to −300 volts was measured to determine a half-exposure sensitivity E_{1/2}. A residual surface potential Vᵣ after exposure for 30 seconds was determined.

(Repetition Characteristics)

The initial dark potential (V_{d}) and the initial light potential (Vₗ) were set to be approximately −600 volts and −200 volts, respectively, at ordinary temperature (23° C.) and ordinary humidity (55% RH), wherein the dark potential means a potential at a dark portion and the light potential means a potential at a light portion. Charging and exposure cycles were repeated 5,000 times using a monochromic light beam of 380 nm to measure changes (ΔV_{d} and ΔVₗ) in V_{d} and Vₗ. The negative sign in the change in the potential means a decrease in absolute value of the potential, whereas the positive sign means an increase in absolute value of the potential.

<Measurement of Transmittance of Charge Transport Layer>

The charge transport layer was peeled from the photosensitive member, and the transmittance of the charge transport layer was measured. FIG. 6 shows transmission spectra, wherein numerals in the drawing represents the identification numbers of the compounds.

The results are shown in Table 1.

### Examples 2 to 5

Electrophotographic photosensitive members were prepared and evaluated as in Example 1 using the compounds shown in Table 1 instead of Compound 1-6. The results are also shown in Table 1 and FIG. 6.

### Comparative Examples 1 and 2

Electrophotographic photosensitive members were prepared and evaluated as in Example 1 using the compounds represented by the following formulae, instead of Compound 1-6. The results are also shown in Table 1.

Comparative Compound 1

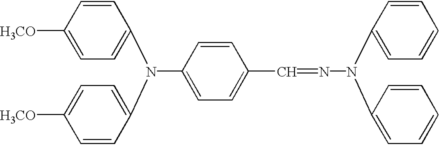

Comparative Compound 2

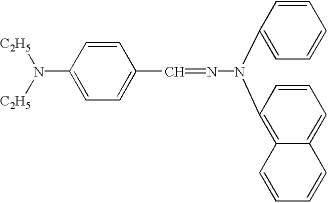

TABLE 1

| | Compound for | | Initial | | | |
|---|---|---|---|---|---|---|
| | Charge | Transmittance | Characteristics | | Repetition | |
| | Transfer | % | E_{1/2} | | Characteristics | |
| | Material | (380 nm) | (μJ/cm²) | Vr (−V) | ΔV_{d} | ΔVₗ |
| Example 1 | 1-6 | 100 | 0.52 | 5 | −20 | +5 |
| Example 2 | 1-7 | 100 | 0.55 | 5 | −25 | −5 |
| Example 3 | 1-9 | 100 | 0.48 | 0 | −20 | 0 |
| Example 4 | 1-10 | 100 | 0.49 | 0 | −20 | +5 |
| Example 5 | 1-11 | 30 | 2.26 | 10 | −40 | +10 |

| | | | |
|---|---|---|---|
| Comparative | Comparative | 0 | Potential was not decreased. |
| Example 1 | Compound 1 | | |
| Comparative | Comparative | 0 | Potential was not decreased. |
| Example 2 | Compound 2 | | |

The results show that the electrophotographic photosensitive members of the present invention have high sensitivity to exposure light of approximately 380 nm, and show high stability in potential and sensitivity after repeated use. An electrophotographic photosensitive member having a charge transport layer having a high transmittance is preferable in view of high sensitivity. The photosensitive members of Comparative Examples 1 and 2 having electron transport layers which do not transmit the 380-nm light do not have sensitivity.

### Examples 6 to 10 and Comparative Examples 3 to 6

Electrophotographic photosensitive members were prepared as in Example 1 using the compounds shown in Table 2 instead of Compound 1-6. Electrophotographic characteristics of the resulting photosensitive members were evaluated as in Example 1 using a monochromatic light beam of 445 nm instead. The results are shown in Table 2 and FIG. 6.

TABLE 2

| | Compound for | | Initial | | | |
|---|---|---|---|---|---|---|
| | Charge | Transmittance | Characteristics | | Repetition | |
| | Transfer | % | E_{1/2} | | Characteristics | |
| | Material | (445 nm) | (μJ/cm²) | Vr (−V) | ΔV_{d} | ΔVₗ |
| Example 6 | 1-7 | 100 | 0.48 | 5 | −25 | 0 |
| Example 7 | 1-9 | 100 | 0.45 | 5 | −20 | 0 |
| Example 8 | 1-10 | 100 | 0.45 | 0 | −25 | 0 |
| Example 9 | 1-11 | 100 | 0.47 | 0 | −20 | +5 |
| Example 10 | 1-28 | 100 | 0.50 | 0 | −30 | −10 |
| Comparative | Comparative | 20 | 7.22 | 60 | −210 | −80 |
| Example 3 | Compound 1 | | | | | |
| Comparative | Comparative | 15 | 6.08 | 50 | −160 | −50 |
| Example 4 | Compound 2 | | | | | |

| | | | |
|---|---|---|---|
| Comparative | 1-31 | 0 | Potential was not decreased. |
| Example 5 | | | |
| Comparative | 1-33 | 0 | Potential was not decreased. |
| Example 6 | | | |

The results show that the electrophotographic photosensitive members of the present invention has high sensitivity to exposure light of approximately 445 nm, and show high stability in potential and sensitivity after repeated use. The photosensitive member using Compound 1-11 shows a high transmittance and high sensitivity at 445 nm, as shown in Example 9, whereas it shows a low transmittance and low sensitivity at 380 nm as shown in Example 5. The photosensitive members of Comparative Examples 3 and 4 using Comparative Compounds 1 and 2, respectively, show significantly lower sensitivity. Since Compounds 1-31 and 1-33 represented by the formula (1) do not transmit 445-nm light, the photosensitive members of Comparative Examples 5 and 6 using these compounds do no have sensitivity.

### Examples 11 to 13

Electrophotographic photosensitive members were prepared as in Example 1 using the compounds shown in Table 3 instead of Compound 1-6. Electrophotographic characteristics of the resulting photosensitive members were evaluated as in Example 1 using a monochromatic light beam of 500 nm instead. The results are shown in Table 3.

TABLE 3

| | Compound for | | Initial | | | |
|---|---|---|---|---|---|---|
| | Charge | Transmittance | Characteristics | | Repetition | |
| | Transfer | % | E_{1/2} | | Characteristics | |
| | Material | (500 nm) | (μJ/cm²) | Vr (−V) | ΔV_{d} | ΔVₗ |
| Example 11 | 1-9 | 100 | 0.47 | 0 | −20 | 0 |
| Example 12 | 1-31 | 93 | 0.65 | 5 | −25 | −5 |
| Example 13 | 1-33 | 100 | 0.50 | 5 | −20 | 0 |

The results shows that the photosensitive members using Compound 1-31 and 1-32 show high transmittances, high sensitivity and excellent repetition characteristics at 500 nm, as shown in Examples 12 and 13, whereas they show low transmittances and low sensitivity at 445 nm as shown in Comparative Examples 5 and 6.

### Examples 14 and 15

A conductive layer coating was prepared by dispersing 50 parts of powdered titanium oxide covered with tin oxide containing 10% antimony oxide, 25 parts of a resol-type phenolic resin, 20 parts of methyl cellosolve, 5 parts of methanol, 0.002 parts of silicon oil (polydimethylsiloxane-polyoxyalkylene copolymer, average molecular weight: 3,000) in a sand mill using 1-mm diameter glass beads. The coating was dip-coated on an aluminum cylinder (30 mm diameter×251 mm) and dried at 140° C. for 30 minutes to form a conductive layer having a thickness of 20 μm.

An underlayer solution was prepared by dissolving 5 parts of N-methoxylated nylon-6 (weight average molecular weight: 52,000) and 10 parts of alcohol-soluble copolymeric nylon (weight average molecular weight: 48,000) into 95 parts of methanol. The underlayer solution was dip-coated on the conductive layer and dried to form an underlying layer having a thickness of 0.8 μm.

To a solution of 10 parts of polyvinyl butyral (Commercial Name: S-LEC, made by Sekisui Chemical Co., Ltd.) in 200 parts of cyclohexanone was added 15 parts of α-oxytitanium phthalocyanine. The mixture was dispersed in a sand mill using 1-mm diameter glass beads for 10 hours, and then was diluted with 200 parts of ethyl acetate. The diluted solution was dip-coated on the underlying layer and dried at 95° C. for 10 minutes to form a charge-generating layer having a thickness of 0.3 μm.

A charge transport layer solution was prepared by dissolving 8 parts of each of the compounds shown in Table 4 and 10 parts of bisphenol-Z type polycarbonate (weight average molecular weight: 45,000) in 65 parts of monochlorobenzene. The solution was coated on the charge-generating layer using a Meyer bar, and dried at 100° C. for one hour to form a charge transport layer having a thickness of approximately 21 μm. Electrophotographic photosensitive members of Examples 14 and 15 were thereby formed.

Each of the electrophotographic photosensitive members was mounted in a modified printer LBP-2000 made by Canon Kabusiki Kaisha having a pulse modulator. The printer had a solid-state blue SHG laser ICD-430 made by Hitachi Metal, Ltd., as a light source (oscillation wavelength: 430 nm), and was modified to a Carlson-type electrophotographic system (reversal developing) including charging-exposure-developing-transfer-cleaning and responding to 600 dpi images. The dark potential V_{d} was set to be −650 volts, the light potential Vₗ was set to be −200 volts, and an image which includes a checkerboard pattern (alternatively on/off pattern) and five-point characters was output. The resulting image was visually evaluated. The results are shown in Table 4.

### Comparative Example 7

An image from the photosensitive member used in Example 14 was evaluated as in Example 14, except that a GaAs semiconductor laser having an oscillation wavelength of 780 nm was used as a light source of the printer. The results are also shown in Table 4.

The results in Table 4 show that the electrophotographic apparatus of the present invention has high reproducibility of dots and characters and can output high-resolution images.

TABLE 4

| | Compound | | | |
|---|---|---|---|---|
| | for Charge | Laser | Dot | |
| | Transfer | Oscillation | Reproduc- | Character |
| | Material | Wavelength | ibility | Reproducibility |
| Example 14 | 1-9 | 430 nm | Clear | Clear |
| Example 15 | 1-10 | 430 nm | Clear | Clear |
| Comparative | 1-9 | 780 nm | Not | Unclear (tailing |
| Example 7 | | | reproduced | in sub-scanning |
| | | | | direction) |

### Examples 16 to 25

Electrophotographic photosensitive members were prepared as in Example 1 using the compounds shown in Table 5 instead of Compounds 1-6 in Example 1, changing the thickness of the charge-generating layer to approximately 0.2 μm, and changing the thickness of the charge transport layer to 25 μm. All charge transport layers of these photosensitive members had transmittances of 30% or more to 450-nm light. For example, the charge transport layer of Example 20 had a transmittance of 100%.

Electrophotographic characteristics of each photosensitive member was measured using an electrostatic copying sheet tester EPA-8100 made by Kawaguchi Electric Co., Ltd.

(Initial Characteristics)

The photosensitive member was charged to a surface potential of −700 volts using a Corona charger, and was exposed with a monochromatic light beam of 450 nm from a monochromator. The dose when the surface potential is decreased to −350 volts was measured to determine a half-exposure sensitivity E_{1/2}. A residual surface potential Vᵣ after exposure for 30 seconds was determined.

(Repetition and Environmental Characteristics)

The initial dark potential (V_{d}) and the initial light potential (Vₗ) were set to be approximately −700 volts and −200 volts, respectively, at ordinary temperature (23° C.) and ordinary humidity (55% RH). Charging and exposure cycles were repeated 5,000 times using a monochromic light beam of 450 nm to measure changes (ΔV_{d} and ΔVₗ) in V_{d} and Vₗ. The environment was changed to a high-temperature, high-humid environment (33° C. and 85% RH) to measure a change in Vₗ from that in normal temperature and normal humidity. The negative sign in the change in the potential means a decrease in absolute value of the potential, whereas the positive sign means an increase in absolute value of the potential.

(Optical Memory)

In each photosensitive member, the initial dark potential (V_{d}) and the initial light potential (Vₗ) for a monochromatic light beam of 450 nm were set to be approximately −700 volts and −200 volts, respectively. The photosensitive member was partly irradiated with a monochromic light beam of 450 nm having an intensity of 20 μW/cm² for 20 minutes, and V_{d} and Vₗ of the photosensitive member were measured to determine the difference ΔV_{d} in the dark potential between the irradiated portion and the unirradiated portion and the difference ΔVₗ in the light potential between the irradiated portion and the unirradiated portion. The negative sign in the potential difference means that the potential at the irradiated portion is lower than that at the nonirradiated portion, and the positive sign means the reverse thereof.

These results are shown in Table 5.

### Example 24

An electrophotographic photosensitive member was prepared and evaluated as in Example 16 using Compound A represented by the following formula instead of Compound 1-7.

The results are also shown in Table 5. The charge transport layer of this photosensitive member had a transmittance of in a range of 30% to less than 90%.

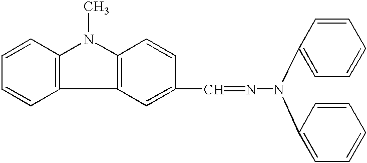

### Example 25

An electrophotographic photosensitive member was prepared and evaluated as in Example 16 using Compound B represented by the following formula instead of Compound 1-7. The results are also shown in Table 5. The charge transport layer of this photosensitive member had a transmittance of in a range of 30% to less than 90%.

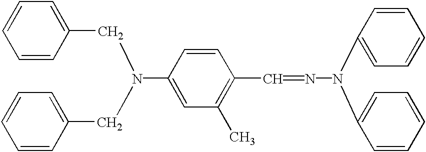

TABLE 5

| | Compound | Initial | | Repetition | | Environmental | Optical | |
|---|---|---|---|---|---|---|---|---|
| | for Charge | Characteristics | | Characteristics | | Characteristic | Memory | |
| | Transfer | E_{1/2} | Vr | ΔV_{d} | ΔV₁ | ΔV₁ | ΔV_{d} | ΔVₗ |
| Example | Material | (μJ/cm²) | (−V) | (V) | (V) | (V) | (V) | (V) |
| Example 16 | 1-7 | 0.49 | 5 | −30 | 0 | 10 | −20 | −15 |
| Example 17 | 1-9 | 0.47 | 5 | −20 | −5 | 5 | −30 | −20 |
| Example 18 | 1-10 | 0.46 | 0 | −25 | −5 | 5 | −10 | −15 |
| Example 19 | 2-1 | 0.55 | 15 | −30 | −30 | 15 | −30 | −20 |
| Example 20 | 2-5 | 0.45 | 5 | −20 | −20 | 5 | −20 | −15 |
| Example 21 | 2-15 | 0.47 | 10 | −25 | −25 | 10 | −25 | −25 |
| Example 22 | 3-12 | 0.44 | 5 | −20 | −20 | 5 | −20 | −25 |
| Example 23 | 3-19 | 0.52 | 15 | −30 | −30 | 15 | −30 | −25 |
| Example 24 | A | 1.88 | 50 | −140 | −80 | 60 | −180 | −115 |
| Example 25 | B | 2.83 | 60 | −180 | −95 | 60 | −170 | −105 |

### Examples 26 to 29

Electrophotographic photosensitive members were prepared and evaluated as in Example 16 using the compounds shown in Table 6 instead of Compound 1-7. The results are shown in Table 6. The charge transport layers of these photosensitive members had transmittances of at least 30%.

### Examples 30 to 33

Electrophotographic photosensitive members were prepared and evaluated as in Example 16 using the compound represented by the following formula instead of the azo compound and using the compounds shown in Table 7 instead of Compound 1-7. The results are shown in Table 7.

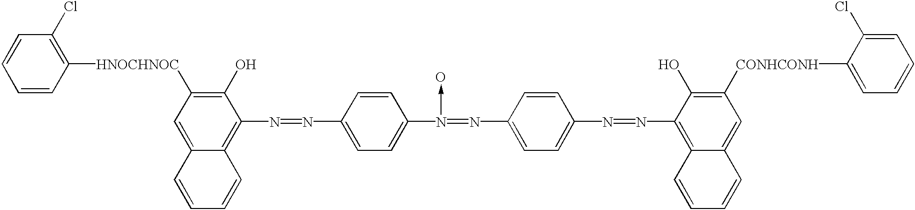

### Examples 34 to 36

Electrophotographic photosensitive members were prepared and evaluated as in Example 30 using the compounds shown in Table 8 instead of Compound 2-5. The results are shown in Table 8.

TABLE 6

| | Compound | Initial | | Repetition | | Environmental | Optical | |
|---|---|---|---|---|---|---|---|---|
| | for Charge | Characteristics | | Characteristics | | Characteristic | Memory | |
| | Transfer | E_{1/2} | Vr | ΔV_{d} | ΔV₁ | ΔV₁ | ΔV_{d} | ΔVₗ |
| Example | Material | (μJ/cm²) | (−V) | (V) | (V) | (V) | (V) | (V) |
| Example 26 | 4-8 | 0.42 | 5 | −20 | −20 | 5 | −30 | −20 |
| Example 27 | 4-9 | 0.49 | 10 | −25 | −25 | 10 | −30 | −25 |
| Example 28 | 4-16 | 0.46 | 10 | −25 | −25 | 5 | −25 | −20 |
| Example 29 | 4-20 | 0.50 | 15 | −30 | −25 | 15 | −35 | −35 |

TABLE 7

| | Compound | Initial | | Repetition | | Environmental | Optical | |
|---|---|---|---|---|---|---|---|---|
| | for Charge | Characteristics | | Characteristics | | Characteristic | Memory | |
| | Transfer | E_{1/2} | Vr | ΔV_{d} | ΔVₗ | ΔVₗ | ΔV_{d} | ΔVₗ |
| Example | Material | (μJ/cm²) | (−V) | (V) | (V) | (V) | (V) | (V) |
| Example 30 | 2-5 | 0.40 | 5 | −15 | −15 | 5 | −20 | −20 |
| Example 31 | 2-15 | 0.45 | 10 | −25 | −25 | 10 | −30 | −20 |
| Example 32 | 3-12 | 0.40 | 5 | −25 | −15 | 5 | −20 | −20 |
| Example 33 | B | 2.59 | 65 | −200 | −90 | 60 | −150 | −80 |

TABLE 8

| | Compound | Initial | | Repetition | | Environmental | Optical | |
|---|---|---|---|---|---|---|---|---|
| | for Charge | Characteristics | | Characteristics | | Characteristic | Memory | |
| | Transfer | E_{1/2} | Vr | ΔV_{d} | ΔV₁ | ΔV₁ | ΔV_{d} | ΔV₁ |
| Example | Material | (μJ/cm²) | (−V) | (V) | (V) | (V) | (V) | (V) |
| Example 34 | 4-7 | 0.41 | 5 | −25 | −20 | 10 | −20 | −20 |
| Example 35 | 4-8 | 0.40 | 5 | −15 | −15 | 5 | −20 | −20 |
| Example 36 | 4-16 | 0.48 | 10 | −25 | −20 | 10 | −30 | −30 |

These results show that electrophotographic photosensitive members using the compounds represented by the formulae (1) to (4) have high sensitivity to short-wavelength exposure light, high stability of potential and sensitivity after repeated use, a low level of environmental dependence, and a low level of optical memory to short-wavelength light.

### Examples 37 to 43

Electrophotographic photosensitive members were prepared as in Example 14, except that charge-generating layers and charge transport layers were formed as follows.

To a solution of 10 parts of polyvinyl butyral (Trade name: S-LEC, made by Sekisui Chemical Co., Ltd.) in 200 parts of cyclohexane was added 20 parts of the azo compound used in Example 16. The mixture was dispersed in a sand mill using 1-mm diameter glass beads for 20 hours and was diluted with 200 parts of ethyl acetate. The dispersion was dip-coated onto the underlying layer and dried at 95° C. for 10 minutes to form a charge-generating layer having a thickness of 0.4 μm.

A charge transport layer solution was prepared by dissolving 9 parts of each of compounds shown in Table 4 and 10 parts of bisphenol-Z type polycarbonate (weight average molecular weight: 45,000) in 65 parts of monochlorobenzene. The solution was dip-coated on the charge-generating layer, and dried at 100° C. for one hour to form a charge transport layer having a thickness of approximately 22 μm. Electrophotographic photosensitive members of Examples 37 and 43 were thereby formed.

Each of the electrophotographic photosensitive members was mounted in a modified printer LBP-2000 made by Canon Kabusiki Kaisha having a pulse modulator and was evaluated. The printer had a solid-state blue SHG laser ICD-430 made by Hitachi Metal, Ltd., as a light source (oscillation wavelength: 430 nm), and was modified to a Carlson-type electrophotographic system (reversal developing) including charging-exposure-developing-transfer-cleaning and responding to 600 dpi images.

(Reproducibility of Dots and Characters)

The initial dark potential (V_{d}) and the initial light potential (Vₗ) were set to be approximately −650 volts and −200 volts, respectively, and an image including a checkerboard pattern (alternatively on/off pattern) and five-point characters was output. The resulting image was visually evaluated. The results are shown in Table 9, wherein “A” indicates “Excellent”, “B” indicates “Good”, “C” indicates “Average”, and “D” indicates “Not Good”.

(Ghost)

At an initial stage, a character pattern corresponding to one turn of the drum was printed at normal temperature (23° C.) and normal humidity (55% RH) to visually observe occurrence of the ghosting phenomenon. Using a pattern for checking durability, 5,000 continuous printing operations were performed. This pattern included vertical and horizontal lines with a width of approximately 2 mm at a distance of 7 mm. Then, an entire black image and a checkerboard pattern (alternatively on/off pattern) and five-point characters were printed to check for the occurrence of the ghosting phenomenon, while changing the developing volume of the machine to F5 (intermediate value) and F9 (high concentration). Rank 5 indicates “No ghosting”, Rank 4 indicates “ghosting is observed in the checkerboard pattern at F9”, Rank 3 indicates “ghosting is observed in the checkerboard pattern at F5”, Rank 2 indicates “ghosting is observed in the entire black pattern at F9”, and Rank 1 indicates “ghosting is observed in the entire black pattern at F5”.

These results are shown in Table 9.

### Comparative Example 8

An electrophotographic photosensitive member was prepared as in Example 37, using the azo compound represented by the following formula.

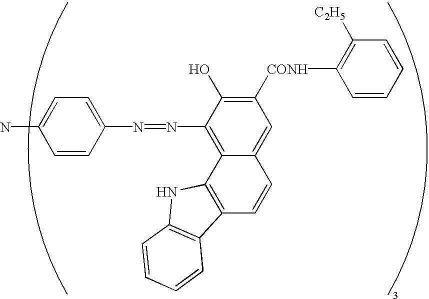

### Comparative Example 9

An electrophotographic photosensitive member was prepared as in Comparative Example 8, using Compound A instead of Compound 1-7.

The photosensitive members of Examples 8 and 9 were evaluated as in Example 37, using a GaAs semiconductor laser having an oscillation wavelength of 780 nm as the light source of the printer. The results are also shown in Table 9.

### Examples 44 to 46

Electrophotographic photosensitive members were prepared and evaluated as in Example 37, using the compounds shown in Table 10 instead of Compound 1-7. The results are shown in Table 10.

TABLE 9

| | Compound for Charge | Laser | Dot | Character | Initial | Ghosting Level after |
|---|---|---|---|---|---|---|
| | Transfer Material | Wavelength (nm) | Reproducibility | Reproducibility | Ghosting Level | Continuous Operation |
| Example 37 | 1-7 | 430 | A | A | 5 | 5 |
| Example 38 | 1-9 | 430 | A | A | 5 | 5 |
| Example 39 | 1-10 | 430 | A | A | 5 | 5 |
| Example 40 | 2-5 | 430 | A | A | 5 | 5 |
| Example 41 | 2-15 | 430 | A | A | 5 | 5 |
| Example 42 | 3-12 | 430 | A | A | 5 | 5 |
| Example 43 | A | 430 | C | C | 2 | 2 |
| Comparative | 2-5 | 780 | C | B | 5 | 5 |
| Example 8 | | | | | | |
| Comparative | A | 780 | D | C | 4 | 3 |
| Example 9 | | | | | | |

TABLE 10

| | Compound for Charge | Laser | Dot | Character | Initial | Ghosting Level after |
|---|---|---|---|---|---|---|
| | Transfer Material | Wavelength (nm) | Reproducibility | Reducibility | Ghosting Level | Continuous Operation |
| Example 44 | 4-7 | 430 | A | A | 5 | 5 |
| Example 45 | 4-8 | 430 | A | A | 5 | 5 |
| Example 46 | 4-16 | 430 | A | A | 5 | 5 |
| Comparative | 4-7 | 780 | C | B | 4 | 4 |
| Example 10 | | | | | | |

### Comparative Example 10

An electrophotographic photosensitive member was prepared and evaluated as in Example 44, using the compound used in Comparative Example 8 instead of Compound 4-7.

The photosensitive member was evaluated as in Example 44, using a GaAs semiconductor laser having an oscillation wavelength of 780 nm as the light source of the printer. The results are also shown in Table 10.

The results in Table 10 show that the electrophotographic apparatus of the present invention exhibits high reproducibility of dots and characters and can output high-resolution images. Clear images without defects can be continuously obtained.

### Examples 47 to 51

Electrophotographic photosensitive members were prepared as in Example 1, except that the thickness of the charge-generating layer was changed to approximately 0.3 μm, the thickness of the charge transport layer was changed to 22 μm, and the compounds shown in Table 11 were used instead of Compound 1-6. Each photosensitive member had a transmittance of 30% or more for 450-nm light. For example, the transmittance of the charge transport layer of Example 48 was 100%. The resulting photosensitive members were evaluated as in Example 16. The results are shown in Table 11.

### Example 52

An electrophotographic photosensitive member was prepared and evaluated as in Example 47, using Compound A having the following formula instead of Compound 5-8. The results are also shown in Table 11. The charge transport layer had a transmittance of in a range of 30% to less than 90%.

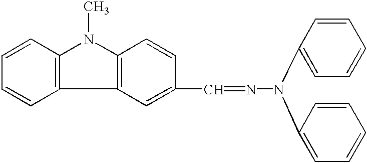

### Example 53

An electrophotographic photosensitive member was prepared and evaluated as in Example 47 using Compound B represented by the following formula instead of Compound 5-8. The results are also shown in Table 11. The charge transport layer of this photosensitive member had a transmittance of in a range of 30% to less than 90%.

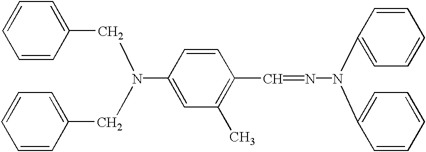

TABLE 11

| | Compound | Initial | | Repetition | | Environmental | Optical | |
|---|---|---|---|---|---|---|---|---|
| | for Charge | Characteristics | | Characteristics | | Characteristic | Memory | |
| | Transfer | E_{1/2} | Vr | ΔV_{d} | ΔVₗ | ΔVₗ | ΔV_{d} | ΔVₗ |
| Example | Material | (μJ/cm²) | (−V) | (V) | (V) | (V) | (V) | (V) |
| Example 47 | 5-8 | 0.54 | 10 | −30 | −30 | 10 | −30 | −30 |
| Example 48 | 5-9 | 0.51 | 5 | −20 | −20 | 5 | −25 | −25 |
| Example 49 | 5-11 | 0.52 | 10 | −25 | −20 | 10 | −25 | −25 |
| Example 50 | 5-13 | 0.55 | 10 | −25 | −25 | 10 | −25 | −25 |
| Example 51 | 5-31 | 0.58 | 15 | −30 | −30 | 15 | −30 | −30 |
| Example 52 | A | 1.81 | 50 | −135 | −70 | 50 | −180 | −130 |
| Example 53 | B | 2.74 | 60 | −200 | −100 | 50 | −160 | −100 |

### Examples 54 to 57

Electrophotographic photosensitive members were prepared and evaluated as in Example 47, using the compounds shown in Table 12 instead of Compound 5-8. The results are shown in Table 12. Each photosensitive member had a transmittance of 30% or more. For example, the transmittance of the charge transport layer of Example 54 was 100%.

### Examples 58 to 61

Electrophotographic photosensitive members were prepared and evaluated as in Example 47, using the compounds shown in Table 13 instead of Compound 5-8. The results are shown in Table 13. Each photosensitive member had a transmittance of 30% or more.

TABLE 12

| | Compound | Initial | | Repetition | | Environmental | Optical | |
|---|---|---|---|---|---|---|---|---|
| | for Charge | Characteristics | | Characteristics | | Characteristic | Memory | |
| | Transfer | E_{1/2} | Vr | ΔV_{d} | ΔV₁ | ΔV₁ | ΔV_{d} | ΔV₁ |
| Example | Material | (μJ/cm²) | (−V) | (V) | (V) | (V) | (V) | (V) |
| Example 54 | 6-11 | 0.53 | 15 | −40 | −30 | 15 | −45 | −35 |
| Example 55 | 6-12 | 0.51 | 10 | −20 | −15 | 10 | −25 | −25 |
| Example 56 | 6-15 | 0.52 | 10 | −35 | −30 | 10 | −30 | −25 |
| Example 57 | 6-56 | 0.50 | 10 | −20 | −10 | 10 | −20 | −20 |

TABLE 13

| | Compound | Initial | | Repetition | | Environmental | Optical | |
|---|---|---|---|---|---|---|---|---|
| | for Charge | Characteristics | | Characteristics | | Characteristic | Memory | |
| | Transfer | E_{1/2} | Vr | ΔV_{d} | ΔV₁ | ΔV₁ | ΔV_{d} | ΔV₁ |
| Example | Material | (μJ/cm²) | (−V) | (V) | (V) | (V) | (V) | (V) |
| Example 58 | 7-16 | 0.60 | 15 | −20 | −30 | 10 | −20 | −25 |
| Example 59 | 7-22 | 0.59 | 15 | −30 | −20 | 10 | −20 | −20 |
| Example 60 | 7-25 | 0.56 | 15 | −25 | −20 | 15 | −25 | −25 |
| Example 61 | 7-26 | 0.55 | 10 | −30 | −25 | 5 | −30 | −25 |

### Examples 62 to 65

Electrophotographic photosensitive members were prepared and evaluated as in Example 47, using the azo compound having the following formula and the compounds shown in Table 14 instead of Compound 5-8. The results are shown in Table 14.

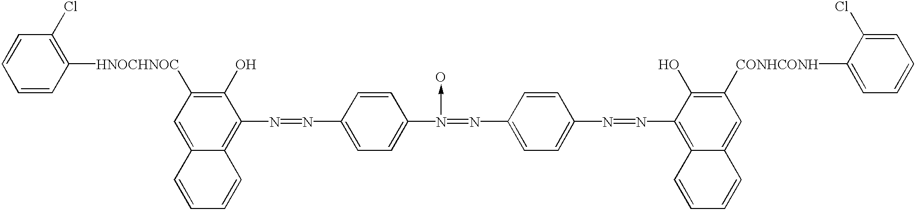

### Examples 66 to 68

Electrophotographic photosensitive members were prepared and evaluated as in Example 62, using the compounds shown in Table 15 instead of Compound 5-9. The results are shown in Table 15.

### Examples 69 to 71

Electrophotographic photosensitive members were prepared and evaluated as in Example 62, using the compounds shown in Table 16 instead of Compound 5-9. The results are shown in Table 16.

TABLE 14

| | Compound | Initial | | Repetition | | Environmental | Optical | |
|---|---|---|---|---|---|---|---|---|
| | for Charge | Characteristics | | Characteristics | | Characteristic | Memory | |
| | Transfer | E_{1/2} | Vr | ΔV_{d} | ΔV₁ | ΔV₁ | ΔV_{d} | ΔV₁ |
| Example | Material | (μJ/cm²) | (−V) | (V) | (V) | (V) | (V) | (V) |
| Example 62 | 5-9 | 0.48 | 5 | −20 | −15 | 10 | −20 | −20 |
| Example 63 | 5-13 | 0.50 | 10 | −25 | −20 | 10 | −25 | −20 |
| Example 64 | 5-31 | 0.53 | 10 | −25 | −25 | 10 | −30 | −25 |
| Example 65 | B | 2.64 | 60 | −170 | −90 | 65 | −110 | −90 |

TABLE 15

| | Compound | Initial | | Repetition | | Environmental | Optical | |
|---|---|---|---|---|---|---|---|---|
| | for Charge | Characteristics | | Characteristics | | Characteristic | Memory | |
| | Transfer | E_{1/2} | Vr | ΔV_{d} | ΔV₁ | ΔV₁ | ΔV_{d} | ΔV₁ |
| Example | Material | (μJ/cm²) | (−V) | (V) | (V) | (V) | (V) | (V) |
| Example 66 | 6-6 | 0.49 | 5 | −20 | −15 | 10 | −20 | −20 |
| Example 67 | 6-19 | 0.52 | 10 | −30 | −25 | 20 | −25 | −20 |
| Example 68 | 6-21 | 0.50 | 5 | −25 | −20 | 10 | −25 | −20 |

TABLE 16

| | Compound | Initial | | Repetition | | Environmental | Optical | |
|---|---|---|---|---|---|---|---|---|
| | for Charge | Characteristics | | Characteristics | | Characteristic | Memory | |
| | Transfer | E_{1/2} | Vr | ΔV_{d} | ΔV₁ | ΔV₁ | ΔV_{d} | ΔV₁ |
| Example | Material | (μJ/cm²) | (−V) | (V) | (V) | (V) | (V) | (V) |
| Example 69 | 7-5 | 0.55 | 10 | −25 | −20 | 10 | −30 | −25 |
| Example 70 | 7-16 | 0.53 | 15 | −30 | −15 | 15 | −30 | −20 |
| Example 71 | 7-25 | 0.52 | 10 | −25 | −30 | 15 | −35 | −30 |

The results in Tables 11 to 16 show that the electrophotographic photosensitive members using the compounds represented by the formulae (5) to (7) have high sensitivity to short-wavelength exposure light, high stability in potential and sensitivity after repeated use, a low level of susceptibility to environmental conditions, and a low level of optical memory to short-wavelength light.

### Examples 72 to 74

Electrophotographic photosensitive members were prepared and evaluated as in Example 37, using the compounds shown in Table 17 instead of Compound 1-7. The results are shown in Table 17.

### Comparative Example 11

An electrophotographic photosensitive member was prepared as in Example 72, except that the azo compound represented by the following formula was used.

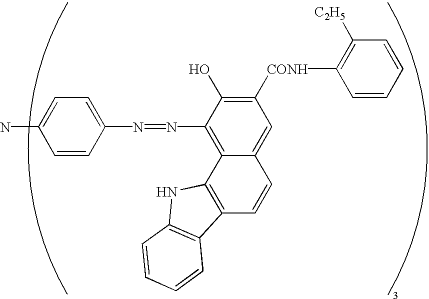

The resulting photosensitive member was evaluated as in Example 72, using a GaAs semiconductor laser having an oscillation wavelength of 780 nm as the light source of the printer. The results are also shown in Table 17.

### Examples 75 to 78

Electrophotographic photosensitive members were prepared and evaluated as in Example 72, using the compounds shown in Table 18 instead of Compound 5-9. The results are shown in Table 18.

### Comparative Example 12

An electrophotographic photosensitive member was prepared as in Example 72, using the azo compound used in Comparative Example 11.

The resulting photosensitive member was evaluated as in Example 72, using a GaAs semiconductor laser having an oscillation wavelength of 780 nm as the light source of the printer. The results are also shown in Table 18.

### Examples 79 to 81

Electrophotographic photosensitive members were prepared and evaluated as in Example 72, using the compounds shown in Table 19 instead of Compound 5-9. The results are shown in Table 19.

### Comparative Example 13

An electrophotographic photosensitive member was prepared as in Example 72, using the azo compound used in Comparative Example 11.

The resulting photosensitive member was evaluated as in Example 72, using a GaAs semiconductor laser having an oscillation wavelength of 780 nm as the light source of the printer. The results are also shown in Table 19.

TABLE 17

| | Compound for | Laser | | | Initial | Ghosting Level |
|---|---|---|---|---|---|---|
| | Charge Transfer | Wavelength | Dot | Character | Ghosting | after Continuous |
| | Material | (nm) | Reproducibility | Reproducibility | Level | Operation |
| Example 72 | 5-9 | 430 | A | A | 5 | 5 |
| Example 73 | 5-11 | 430 | A | A | 5 | 5 |
| Example 74 | 5-16 | 430 | A | A | 5 | 5 |
| Comparative | 1-9 | 780 | C | B | 5 | 4 |
| Example 11 | | | | | | |

TABLE 18

| | Compound for | Laser | | | Initial | Ghosting Level |
|---|---|---|---|---|---|---|
| | Charge Transfer | Wavelength | Dot | Character | Ghosting | after Continuous |
| | Material | (nm) | Reproducibility | Reproducibility | Level | Operation |
| Example 75 | 6-6 | 430 | A | A | 5 | 5 |
| Example 76 | 6-9 | 430 | A | A | 5 | 5 |
| Example 78 | 6-21 | 430 | A | A | 5 | 5 |
| Comparative | 6-6 | 780 | C | B | 5 | 4 |
| Example 12 | | | | | | |

TABLE 19

| | Compound for | Laser | | | | Ghost Level |
|---|---|---|---|---|---|---|
| | Charge Transfer | Wavelength | Dot | Character | Initial | after Continuous |
| | Material | (nm) | Reproducibility | Reproducibility | Ghost Level | Operation |
| Example 79 | 7-16 | 430 | A | A | 5 | 5 |
| Example 80 | 7-22 | 430 | A | A | 5 | 5 |
| Example 81 | 7-26 | 430 | A | A | 5 | 5 |
| Comparative | 7-16 | 780 | C | C | 4 | 4 |
| Example 13 | | | | | | |

The results in Tables 18 and 19 show that the electrophotographic apparatus of the present invention has high reproducibility of dots and characters and can output high-resolution images.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An electrophotographic photosensitive member, irradiated with semiconductor laser light having a wavelength of 380 to 500 nm, comprising:
a conductive substrate;
a charge-generating layer formed thereon; and
a charge transport layer formed thereon, the charge transport layer having a transmittance of at least 30% for the semiconductor laser light.

2. An electrophotographic photosensitive member according to claim 1, wherein the semiconductor laser light has a wavelength of 400 to 450 nm.

3. An electrophotographic photosensitive member according to claim 1, wherein the charge transport layer has a transmittance of 90% or more.

4. An electrophotographic photosensitive member according to claim 1, wherein the charge transport layer contains a charge transfer material represented by the following formula (1): 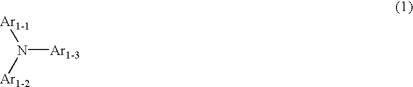
wherein Ar₁₋₁, Ar₁₋₂ and Ar₁₋₃ each is a substituted or unsubstituted aromatic group.

5. An electrophotographic photosensitive member according to claim 1, wherein the charge transport layer contains a charge transfer material represented by the following formula (2): 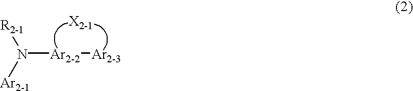
wherein Ar₂₋₁ is a substituted or unsubstituted aromatic group, Ar₂₋₂ and Ar₂₋₃ each is a substituted or unsubstituted aromatic group, R₂₋₁ is a substituted or unsubstituted alkyl group, a substituted or unsubstituted aralkyl group, a substituted or unsubstituted vinyl group, or a substituted or unsubstituted aromatic group, X₂₋₁ is a divalent organic group, and R₂₋₁ and Ar₂₋₁ may bond to each other to form a ring.

6. An electrophotographic photosensitive member according to claim 1, wherein the charge transport layer contains a charge transfer material represented by the following formula (3): 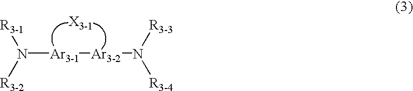
wherein Ar₃₋₁ and Ar₃₋₂ each is a substituted or unsubstituted aromatic group, R₃₋₁ to R₃₋₄ each is a substituted or unsubstituted alkyl group, a substituted or unsubstituted aralkyl group, a substituted or unsubstituted vinyl group, or a substituted or unsubstituted aromatic group wherein at least two of R₃₋₁ to R₃₋₄ are the substituted or unsubstituted aromatic groups, X₃₋₁ is a divalent organic group, and R₃₋₁ and R₃₋₂, or R₃₋₃ and R₃₋₄ may bond to each other to form a ring.

7. An electrophotographic photosensitive member according to claim 1, wherein the charge transport layer contains a charge transfer material represented by the following formula (4): 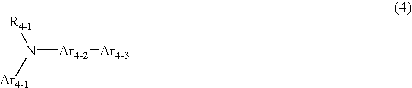
wherein Ar₄₋₁ and Ar₄₋₃ each is a substituted or unsubstituted aromatic group, Ar₄₋₂ is a substituted or unsubstituted aromatic group, R₄₋₁ is a substituted or unsubstituted alkyl group, a substituted or unsubstituted aralkyl group, a substituted or unsubstituted vinyl group, or a substituted or unsubstituted aromatic group, and Ar₄₋₁ and R₄₋₁ may bond to each other to form a ring.

8. An electrophotographic photosensitive member according to claim 1, wherein the charge transport layer contains a charge transfer material represented by the following formula (5): 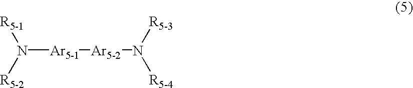
wherein Ar₅₋₁ and Ar₅₋₂ each is a substituted or unsubstituted aromatic group, R₅₋₁ to R₅₋₄ each is a substituted or unsubstituted alkyl group, a substituted or unsubstituted aralkyl group, a substituted or unsubstituted vinyl group, or a substituted or unsubstituted aromatic group wherein at least two of R₅₋₁ to R₅₋₄ are the substituted or unsubstituted aromatic groups, and R₅₋₁ and R₅₋₂ or R₅₋₃ and R₅₋₄ may bond to each other to form a ring.

9. An electrophotographic photosensitive member according to claim 1, wherein the charge transport layer contains a charge transfer material represented by the following formula (6): 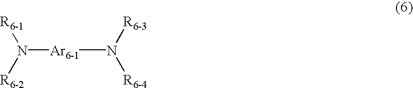
wherein Ar₆₋₁ is a substituted or unsubstituted aromatic group, R₆₋₁ to R₆₋₄ each is a substituted or unsubstituted alkyl group, a substituted or unsubstituted aralkyl group, a substituted or unsubstituted vinyl group, or a substituted or unsubstituted aromatic group wherein at least two of R₆₋₁ to R₆₋₄ are the substituted or unsubstituted aromatic groups, and R₆₋₁ and R₆₋₂ or R₆₋₃ and R₆₋₄ may bond to each other to form a ring.

10. An electrophotographic photosensitive member according to claim 1, wherein the charge transport layer contains a charge transfer material represented by the following formula (7): 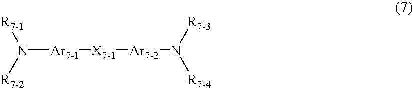
wherein Ar₇₋₁ and Ar₇₋₂ each is a substituted or unsubstituted aromatic group, R₇₋₁ to R₇₋₄ each is a substituted or unsubstituted alkyl group, a substituted or unsubstituted aralkyl group, a substituted or unsubstituted vinyl group, or a substituted or unsubstituted aromatic group wherein at least two of R₇₋₁ to R₇₋₄ are the substituted or unsubstituted aromatic groups, R₇₋₁ and R₇₋₂ or R₇₋₃ and R₇₋₄ may bond to each other to form a ring, and X₇₋₁ is a divalent organic group.

11. A process cartridge mountable to and detachable from an electrophotographic apparatus comprising:
an electrophotographic photosensitive member; and
at least one means selected from a charging means, a developing means and a cleaning means, the electrophotographic photosensitive member being integratedly supported by said at least one means;
wherein the electrophotographic photosensitive member comprises a conductive substrate, a charge-generating layer formed thereon, and a charge transport layer formed thereon, the charge transport layer having a transmittance of at least 30% for the semiconductor laser light.

12. An electrophotographic apparatus comprising:
an electrophotographic photosensitive member;
a charging means;
an exposure means;
a developing means; and
a transfer means;
wherein the exposure means comprises a semiconductor laser having an oscillation wavelength of 380 to 500 nm as an exposure light source, and
the electrophotographic photosensitive member comprises a conductive substrate, a charge-generating layer formed thereon, and a charge transport layer formed thereon, the charge transport layer having a transmittance of at least 30% for the semiconductor laser light.
